(19) United States
(12) Patent Application Publication
(10) Pub. No.: US 2020/0130842 A1
(43) Pub. Date: Apr. 30, 2020

(54) LAVATORY MONUMENT FOR AIRCRAFT

(71) Applicant: The Boeing Company, Chicago, IL (US)

(72) Inventors: Stephen M. Young, Los Alamitos, CA (US); Kevin Griffith Swanson, Lake Forest Park, WA (US)

(21) Appl. No.: 16/172,327

(22) Filed: Oct. 26, 2018

(51) Int. Cl. B64D 11/02; B64C 1/14

(52) U.S. Cl. CPC B64D 11/02; B64D 2011/0046; B64C 1/1461; B64C 1/1423

(57) ABSTRACT

An aircraft including a lavatory monument. The lavatory monument includes an outboard wall and a shell wall removably connected to the outboard wall, both walls extending radially inwardly relative to a fuselage of the aircraft. The lavatory monument also includes a floor panel connected to and between the outboard wall and the shell wall. The lavatory monument also includes a toilet connected to the floor panel. The lavatory monument also includes a plurality of lavatory fixtures individually removably attached to at least one of: the outboard wall, the shell wall, the floor panel, or the toilet. Each of the plurality of lavatory fixtures is individually removable. Common interface points on each of the plurality of lavatory fixtures are unchangeable with respect to the lavatory monument.

### CROSS-REFERENCE TO RELATED APPLICATIONS

This application is related to U.S. Pat. No. ______ filed concurrently with this application, and titled “Improved Aft Wall for a Lavatory Monument of an Aircraft”, Attorney Docket No. 18-0455-US-NP; this application is related to U.S. Pat. No. ______ filed concurrently with this application, and titled “Modular Faucet System for Aircraft”, Attorney Docket No. 18-0497-US-NP; the entire disclosures of which are incorporated by reference herein.

### BACKGROUND INFORMATION

### 1. Field

The present disclosure relates to aircraft and, more particularly, to aircraft modular lavatory monuments having replaceable fixtures.

### 2. Background

Aircraft are subject to strict regulatory compliance standards in nearly every country in the world. In the United States, the Federal Aviation Administration governs the standards for manufacturing, maintaining, and operating aircraft and ancillary concerns such as operating airports. The Federal Aviation Regulations (FARs) are organized into sections known as parts due to the organization within the Code of Federal Regulations. There are dozens of parts divided into tens of thousands of separate sections, many of which have large numbers of researchers and technicians using them at any given time. In all, there are many thousands of pages of regulations that must be observed across the aircraft industry.

Of the FARs, part 21 deals with certification procedures for products and parts. These FARs also interact with other regulations, such as but not limited to parts 23-39 (dealing with airworthiness standards for different types of aircraft), part 43 (maintenance), part 119 (certification of carriers), part 121 (operating requirements), part 125 (large passenger aircraft), and others.

Because of these extensive regulations, a technician or engineer cannot simply replace a part with something he or she sees in non-aircraft markets. Instead, new or replacement parts must either be pre-approved per regulations, or approval must be obtained from the Federal Aviation Administration (or other regulatory body in countries other than the United States) in order to use new or different parts.

For example, aircraft lavatories, like any other parts of the aircraft, are subject to strict regulatory requirements. A great many design features are required, right down to the height at which fluid lines are placed in the lavatory. Because of these regulations, aircraft lavatories for commercial aircraft have traditionally been constructed as whole units, known as “monuments”. More generally, a “monument” is a large, replaceable section of an inside of the aircraft designed for a purpose, such as but not limited to a lavatory. The monument design scheme allows, for example, a lavatory for a commercial aircraft to be approved by regulators as a whole and then installed in an aircraft.

However, this regulatory and design scheme results in a problem: if even a single component of the inside of the lavatory requires replacement, such as if a merely decorative flaw were to appear in a backsplash, then the entire lavatory monument (walls, floor, toilet, sink, everything) has to be removed and a new lavatory monument installed. It is not possible to simply remove and replace the backsplash. This problem is not easily solved because the heavy regulatory environment leads engineers to design entire lavatory monuments to meet regulatory requirements. To date, no solution to this problem has been presented. Instead, carriers and manufacturers have had to bear the cost of replacing entire lavatory monuments for even minor adjustments or corrections to a lavatory.

### SUMMARY

The illustrative embodiments provide for an aircraft. The aircraft includes a fuselage and a lavatory monument removably mounted inside the fuselage. The lavatory monument includes an outboard wall removably connected to an inside surface of the fuselage. The lavatory monument also includes a shell wall removably connected to the outboard wall and extending radially inwardly relative to the fuselage. The lavatory monument also includes a floor panel connected to and between the outboard wall and the shell wall. The lavatory monument also includes a toilet connected to the floor panel. The lavatory monument also includes a plurality of lavatory fixtures individually removably attached to at least one of: the outboard wall, the shell wall, the floor panel, or the toilet. Each of the plurality of lavatory fixtures is configured to be individually removable. Common interface points on each of the plurality of lavatory fixtures are unchangeable with respect to the lavatory monument.

The illustrative embodiments also contemplate a method of modifying the above aircraft. In particular, the illustrative embodiments contemplate removing the fixture while retaining the lavatory monument in place; and replacing the fixture.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an exploded view of an aircraft modular lavatory monument in accordance with an illustrative embodiment;

FIG. 2A through FIG. 2E are illustrations of portions and options of an upper cabinet of an aircraft modular lavatory monument in accordance with an illustrative embodiment;

FIG. 3A through FIG. 3C are illustrations of backsplash options for an aircraft modular lavatory monument in accordance with an illustrative embodiment;

FIG. 4A through FIG. 4E are illustrations of sink and counter top options for an aircraft modular lavatory monument in accordance with an illustrative embodiment;

FIG. 5A and FIG. 5B are illustrations of sink and countertop options for an aircraft modular lavatory monument in accordance with an illustrative embodiment;

FIG. 6A through FIG. 6C are illustrations of lower storage and wall options for an aircraft modular lavatory monument in accordance with an illustrative embodiment;

FIG. 7A and FIG. 7B are illustrations of outboard wall and ceiling options for an aircraft modular lavatory monument in accordance with an illustrative embodiment;

FIG. 8A through FIG. 8C are illustrations of aft wall options for an aircraft modular lavatory monument in accordance with an illustrative embodiment;

FIG. 9A and FIG. 9B are illustrations of toilet shroud options for an aircraft modular lavatory monument in accordance with an illustrative embodiment;

FIG. 10A through FIG. 10D are illustrations of toilet shroud options for an aircraft modular lavatory monument in accordance with an illustrative embodiment;

FIG. 11A through FIG. 11D are illustrations of door options for an aircraft modular lavatory monument in accordance with an illustrative embodiment;

FIG. 12A and FIG. 12B are illustrations of ballistic intrusion barrier options for an aircraft modular lavatory monument in accordance with an illustrative embodiment;

FIG. 13 is an illustration of a block diagram of a lighting system for an aircraft modular lavatory monument in accordance with an illustrative embodiment;

FIG. 14 is an illustration of an arrangement of lights for a lighting system for an aircraft modular lavatory monument in accordance with an illustrative embodiment;

FIG. 15 is an illustration of a block diagram of a water system for an aircraft modular lavatory monument in accordance with an illustrative embodiment;

FIG. 16 is an illustration of a block diagram for a control system for an aircraft modular lavatory monument in accordance with an illustrative embodiment;

FIG. 17 is an illustration of a block diagram of an aircraft with a modular lavatory monument in accordance with an illustrative embodiment;

FIG. 18 is an illustration of a flowchart of a method for replacing a fixture in an aircraft modular lavatory monument in accordance with an illustrative embodiment;

FIG. 19 is an illustration of an aircraft manufacturing and service method in the form of a block diagram in accordance with an illustrative embodiment; and

FIG. 20 is an illustration of an aircraft in the form of a block diagram in accordance with an illustrative embodiment.

### DETAILED DESCRIPTION

The different illustrative embodiments recognize and take into account a number of different considerations. For example, the illustrative embodiments recognize and take into account that, due to the heavy regulatory environment of aircraft, aircraft lavatory monuments are not modular. In other words, while the monument itself is replaceable, the components and parts inside the lavatory are not.

In an effort to support customers with increasing demand for customization and features, the illustrative embodiments provide for an aircraft lavatory monument design was developed with the intention of providing additional feature selections, which would allow customers to differentiate their brands and provide increased levels of service. To accomplish the goal of allowing maximum customization with minimal engineering impact, a modular design system was developed. The modular nature of the concept allows multiple sub-assemblies to be removed and replaced without impacting the surrounding assemblies.

This modularity is achieved, while maintaining the requirements of a heavy regulatory environment, by creating common interface points on each sub assembly that are not allowed to change throughout the different modular packages offered. Additionally, the design is carefully laid out such that each component has an acceptable removal envelope, and optimized to reduce the quantity and accessibility of fasteners required.

As used herein, the term “modular” refers to a component which is removably attached to at least one other component or fixture. The term “modular” with respect to a component or fixture automatically contemplates common interface points on the component that are unchangeable with respect to the lavatory monument; that is, the common interface points are not considered “modular.”

The terms “removably attached” or “removeable attachment” refer to a component, fixture, or connection that is easily or quickly replaceable either by hand or the use of tools in a manner that is considered “easy” or “fast” by one of ordinary skill in the art. The terms “easy” or “fast” are determined relative to components that are fixedly attached, or stated differently, intended for permanent and unchanged attachment or formed monolithically with another part of a component. As used herein, the term “about” or “approximately” when used with respect to measurements is determined by the ordinary artisan and is within acceptable engineering tolerances in the regulatory scheme for a given jurisdiction, such as but not limited to the Federal Aviation Administration Federal Aviation Regulations. The term “fixture” refers to a component that can be replaced as an individual unit, such as but not limited to a sink, a faucet, a cabinet, an alcove panel shaped to present an alcove inside the lavatory monument, a toilet paper holder, a drawer, a liquid hose line, a soap dispenser, a soap holder, a towel dispenser, a towel holder, a drawer, a backsplash, a waste receptacle, a counter top, a light strip, a light bulb, a lightable sign, a mirror, a display device, a speaker, a crew signal button, a switch, a panel, a cup holder, an airsick bag dispenser, a tissue dispenser, a sanitary napkin dispenser, a cologne rack, and a shelf.

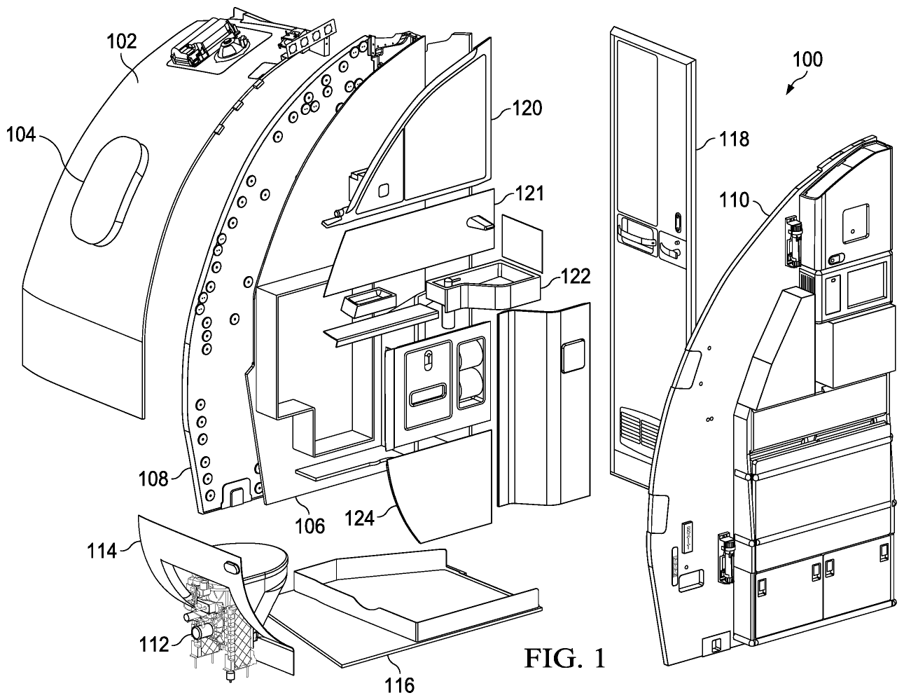

Turning now to FIG. 1, an illustration of an exploded view of an aircraft modular lavatory monument is depicted in accordance with an illustrative embodiment. Aircraft modular lavatory monument 100, as indicated above, is provided with common interface points on each sub assembly (the plurality of removably attached lavatory fixtures) that are not allowed to change throughout the different modular packages offered. Thus, common interface points on each of the plurality of lavatory fixtures are unchangeable with respect to the lavatory monument. Additionally, the design is laid out such that each component (the plurality of removably attached lavatory fixtures) has an acceptable removal envelope, and optimized to reduce the quantity of and increase the accessibility of fasteners required.

Aircraft modular lavatory monument 100 includes modular outboard wall 102 which is intended for removeable attachment to a fuselage of an aircraft. Thus, modular outboard wall 102 may be considered part of a frame for aircraft modular lavatory monument 100. Optionally, aircraft modular lavatory monument 100 may be provided with window 104, which is placed, sized, and dimensioned to match a window in the corresponding model of aircraft for which aircraft modular lavatory monument 100 is intended.

Aircraft modular lavatory monument 100 also includes modular shell wall 106, which also forms part of the frame for aircraft modular lavatory monument 100. Optionally, ballistic intrusion barrier 108 may also be provided, if desirable. In a still further option, modular shell wall 106 may be replaced by ballistic intrusion barrier 108, in which case ballistic intrusion barrier 108 is “modular.” In either case, the corresponding wall or barrier is removably attached to modular outboard wall 102 and radiates inwardly towards a central axis of the fuselage of the aircraft. While shown as radiating at a perpendicular angle to modular outboard wall 102, the angle shown may be varied in different illustrative embodiments.

Aircraft modular lavatory monument 100 also includes modular aft wall 110. The term “aft” is used herein merely to distinguish modular shell wall 106 from modular aft wall 110. Modular aft wall 110 also forms part of the frame of aircraft modular lavatory monument 100. While the typical aircraft modular lavatory monument 100 will have modular aft wall 110 actually facing the aft portion of an aircraft, this arrangement is not necessary for all illustrative embodiments. For example, the components shown on modular aft wall 110 could face the “forward” portion of the aircraft, at which point modular aft wall 110 becomes a “modular forward wall”. Note, also, that the various sub-components or fixtures shown on either modular shell wall 106 or modular aft wall 110 may be re-arranged, reversed with respect to which side of the wall to which the are attached, or otherwise altered with more or fewer sub-components or fixtures.

Aircraft modular lavatory monument 100 also includes modular toilet 112, modular toilet shroud 114 attached to modular toilet 112, and modular floor pan 116 to which modular toilet 112 is also attached. Modular toilet 112 is attached to a waste disposal system contained in the fuselage of the aircraft. Optionally, a bidet may be provided inside or next to modular toilet 112. In the latter case, the bidet may have a bidet shroud similar to modular toilet shroud 114 shown in FIG. 1.

Aircraft modular lavatory monument 100 also includes modular door 118. Modular door 118 may be a folding door, a slab door, a hinged door, a pocket door, or any other desirable door design. Modular door 118 is removably connected to one or both of modular shell wall 106 or modular aft wall 110.

Aircraft modular lavatory monument 100 also includes modular upper cabinet system 120. Modular upper cabinet system 120 is one or more modular cabinets, drawers, mirrors or other fixtures which are attached at or about chest height or higher for an average adult female or male (or possibly a child in some illustrative embodiments).

Aircraft modular lavatory monument 100 also includes backsplash assembly 121. Backsplash assembly 121 is independently removably attached to modular shell wall 106 relative to the other components of aircraft modular lavatory monument 100.

Aircraft modular lavatory monument 100 also includes modular counter system 122. Modular counter system 122 is one or more modular sinks, backsplashes, waste receptacle openings, soap holders, soap dispensers, towel dispensers, or other fixtures that are about between about waist and chest height for an average adult female or male (or possibly a child in some illustrative embodiments).

Aircraft modular lavatory monument 100 also includes lower cabinet assembly 124. Lower cabinet assembly 124 is one or more modular cabinets, toilet paper dispensers, doors, drawers, tissue dispensers, waste receptacles, or other fixtures that are about between about waist and chest height for an average adult female or male (or possibly a child in some illustrative embodiments). In some illustrative examples, lower cabinet assembly 124, may be referred to as a modular lower cabinet assembly.

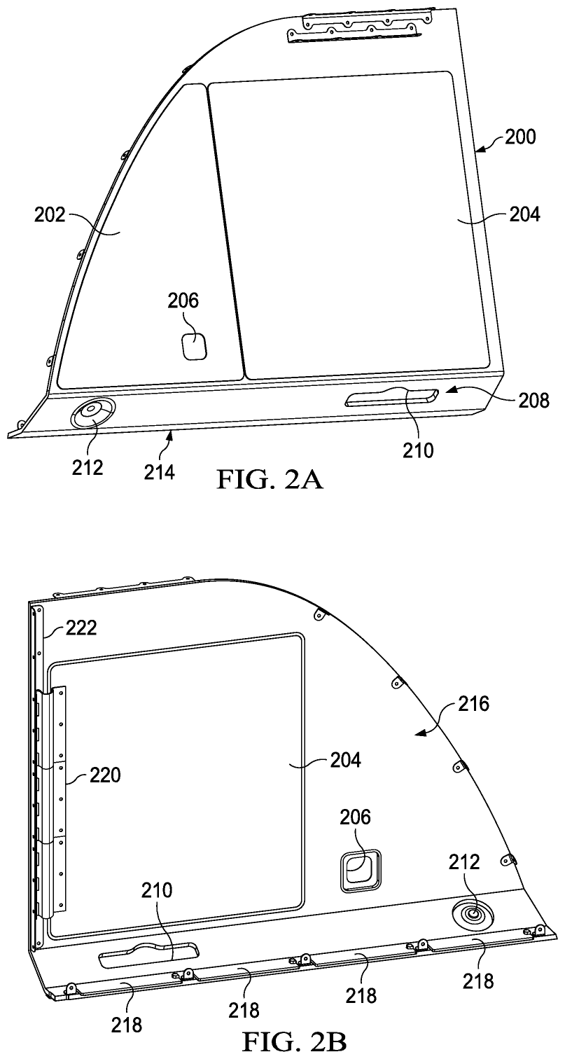

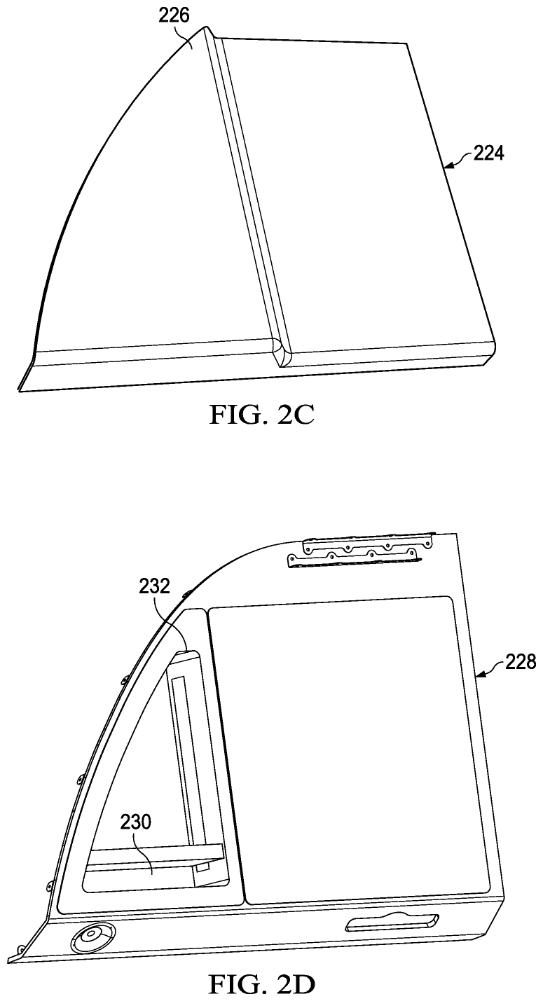

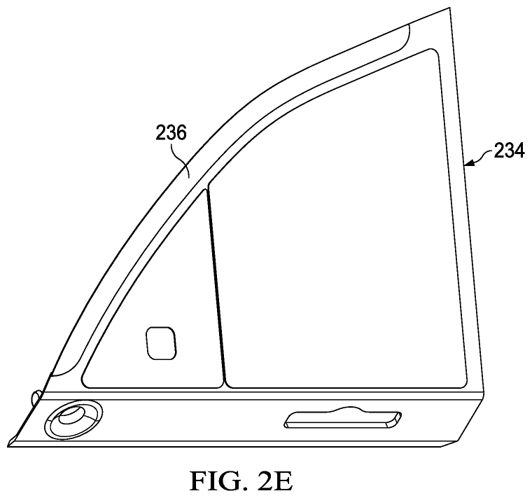

The various modular components and fixtures shown in FIG. 1 may be varied. More or fewer fixtures or walls may be present. The arrangement, type, and style of fixtures or wall may be varied. Additional details regarding some of these variations are described below with respect to FIG. 2 through FIG. 14.

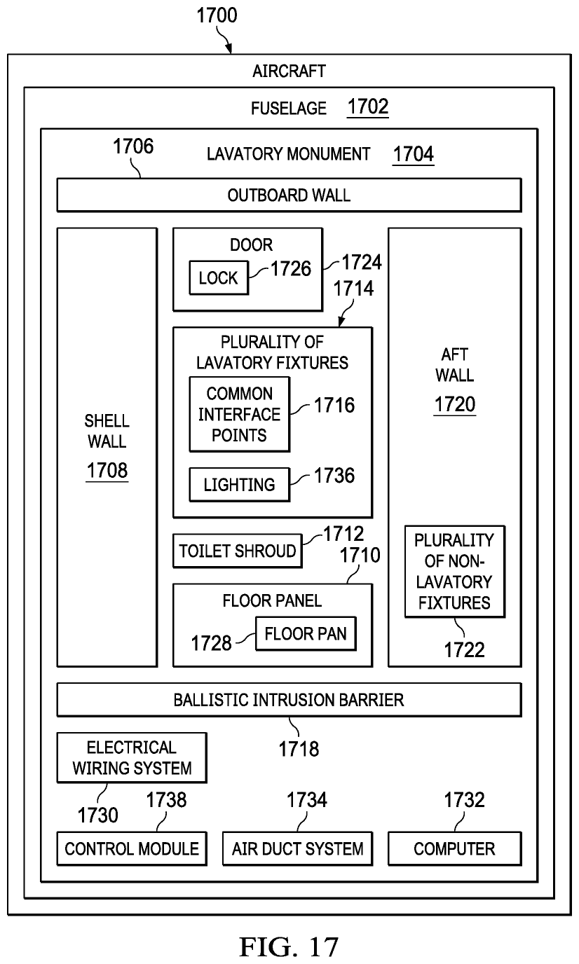

FIG. 2A through FIG. 2E are illustrations of portions and options of an upper cabinet of an aircraft modular lavatory monument in accordance with an illustrative embodiment. Collectively, FIG. 2A through FIG. 2E may be referred to as “FIG. 2”. FIG. 2 refers to options for components for modular upper cabinet system 120 of FIG. 1. FIG. 2 presents physical implementations of a lavatory fixture of plurality of lavatory fixtures 1714 of FIG. 17.

FIG. 2A shows option 200 with a flat panel 201. Option 200 has dual mirrors, mirror 202 and mirror 204. As depicted, mirror 202 includes a tissue cutout 206 for dispensing tissues. In some illustrative examples, tissue cutout 206 is optional. In some illustrative examples, mirror 204 may also serve as a door. Mirror 204 may be provided with a hidden latch system and hinge extrusions for actuation and replaceable attachment. In some illustrative examples, mirror 204 includes in-mirror lighting and/or signs (not shown) such as a “return to seat” lighted signal.

Option 200 includes flange 208. As depicted, flange 208 includes opening 210 for dispensing paper towels, tissues, or other desirable items. In some illustrative examples, opening 210 is optional.

As depicted, flange 208 includes plenum 212. In some illustrative examples, plenum 212 is connected to the aircraft air duct system and is used to dispense air. In some illustrative examples, plenum 212 may be referred to as an environmental control system (ECS) plenum. In some illustrative examples, plenum 212 is used to dispense heated air. In some illustrative examples, air provided by plenum 212 is used to aid a user in drying their hands. In some illustrative examples, air provided by plenum 212 is used to dry surfaces within the lavatory, such as countertops. In some illustrative examples, plenum 212 is optional.

As depicted, flange 208 may also include lighting 214. In some illustrative examples, lighting 214 is called a light lens, a light, or an under-flange light. Lighting 214 may be provided by any desirable quantity or design of lighting items. In some illustrative examples, lighting 214 is positioned to illuminate a countertop of the lavatory.

FIG. 2B shows backside 216 of option 200. In backside 216, lighting 214 takes the form of countertop lights 218. Also shown is hinge 220 used for opening and closing mirror 204 when mirror 204 acts as a door. Hinge 220 may be any desirable design of hinge. In some illustrative examples, hinge 220 is a gooseneck piano hinge, possibly spring loaded to open. In some illustrative examples, hinge 220 is connected to bracket 222. Bracket 222 connects option 200 to an outboard wall. In some illustrative examples, hinge 220 removably connects mirror 204 of option 200 to the outboard wall.

FIG. 2C shows option 224, with a flat panel and a bumped-out storage area 226 outboard. FIG. 2D shows option 228 which is a panel that replaces stowage with an open shelf 230 and a one-piece molded alcove feature 232. FIG. 2E illustrates option 234, which is a panel that includes light 236. Light 236 provides illumination around mirror 202 and mirror 204. Light 236 may provide illumination for a passenger within the lavatory. In some illustrative examples, light 236 may be referred to as a wash light and lens.

With respect to the upper cabinet area, the free space behind the upper cabinet may be used to house many of the electronics components for the lavatory. The aircraft interface to wire bundle enters the lavatory at upper cabinet. The lavatory controller brain (described further below) acts as hub to take inputs and use them for distribution and control.

A master lighting switch housed inside mirrored door area allows maintenance technicians to flip lights to full bright for cleaning operations. The illustrative embodiments also provide for access to control additional user inputs, such as lighting color adjustment, scene selection, tamper indication display, etc. If desirable, a ground stud interface may be provided. Additionally, electrical breakers, relays, power boxes, and other electrical features may be provided. If desirable, a smart mirror or two-way mirror may be added, as well as a virtual window control and power boxes.

The following are features that may be provided to various components of the upper cabinet system: A smart mirror system (with integral lighting in screen); a tamper indication system; an in-mirror attendant call switch (capacitive); a two-way mirror; in-mirror lighting/signage with multiple colors and signs available; a reliably mount mirror in correct location; a hidden latch system for the door; tissue and/or towel dispensers; a spring loaded gooseneck hinge; countertop lighting (multiple colors). The upper cabinet system is easily removable without affecting ceiling, backsplash, inboard walls, or outboard walls.

Other options are possible. Other designs of the panels are possible, with more or fewer or different features. Optionally, the space behind the upper cabinets may be reserved for future fixture additions. Thus, the illustrative embodiments are not necessarily limited to the illustrative embodiments shown in FIG. 2.

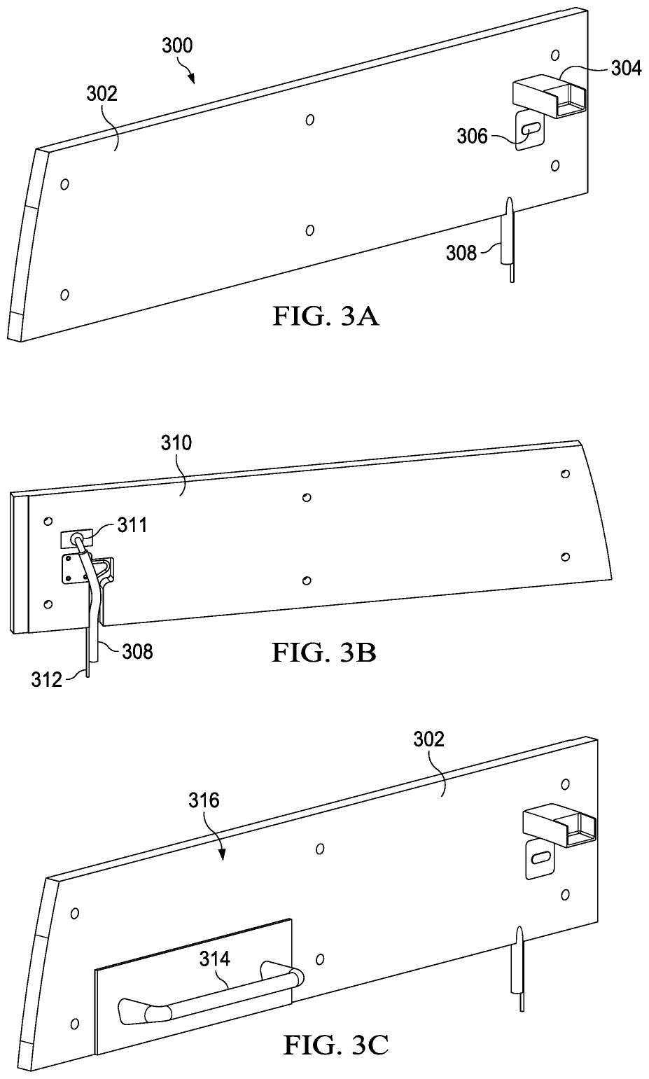

FIG. 3A through FIG. 3C are illustrations of backsplash options for an aircraft modular lavatory monument in accordance with an illustrative embodiment. Together, FIG. 3A through FIG. 3C may be referred to as “FIG. 3.” FIG. 3 illustrates options for backsplash assembly 121 of FIG. 1. In some illustrative examples, an implementation shown in FIG. 3 may be positioned beneath any desirable option of the options of FIG. 2.

FIG. 3 presents physical implementations of at least one lavatory fixture of plurality of lavatory fixtures 1714 of FIG. 17. For example, backsplash assembly 300 may be an implementation of a lavatory fixture of plurality of lavatory fixtures 1714 of FIG. 17. Faucet 304 may be an implementation of a lavatory fixture of plurality of lavatory fixtures 1714 of FIG. 17.

Backsplash assembly 300 includes backsplash sheet 302, which may be provided in a variety of different styles and colors. Faucet 304 extends from backsplash sheet 302. In some illustrative examples, faucet 304 is removably attached to backsplash sheet 302. In some illustrative examples, faucet 304 is attached to a separate component of the lavatory, such as modular shell wall. In these illustrative examples, backsplash sheet 302 is slid over faucet 304. In these illustrative examples, backsplash sheet 302 has an opening through which faucet 304 extends.

Faucet 304 has any desirable aesthetic design. Faucet 304 may be provided in a variety of different styles and colors. Faucet 304 is actuated using any desirable method. An actuator may include a knob, switch, sensor, or any other actuation device. As depicted in FIG. 3A, sensor 306 is present to actuate faucet 304. In some illustrative examples, sensor 306 is removably attached to backsplash sheet 302. In some illustrative examples, sensor 306 is removably attached to backsplash sheet 302 independently of faucet 304. In some illustrative examples, sensor 306 is attached to a different component of the lavatory, such as a modular shell wall.

Sensor 306 may be a touchless sensor, or any other desirable sensor, for sensing when a user desires to dispense water from faucet 304. Sensor 306 actuates one or more valves for dispensing water, possibly with hot and cold options, through faucet 304. Water line 308, which is connected to the aircraft's water distribution system when aircraft modular lavatory monument 100 is connected to the aircraft umbilical, provides a conduit for water.

FIG. 3B illustrates back side 310 of backsplash sheet 302. Water line 308 is shown, as is connector 311 and electrical pigtail 312 for providing electrical power to sensor 306 and possibly other components of aircraft modular lavatory monument 100.

In this illustrative example, faucet 304 is removably attached to backsplash sheet. As depicted, sensor 306 is removably attached to backsplash sheet 302 independently of faucet 304.

FIG. 3C illustrates options for backsplash sheet 302. In particular, towel rack or grip handle 314 is shown removably attached to backsplash sheet 302. Other options, or different options, may also be mounted on backsplash sheet 302. More than one such options may be provided. For example, cologne racks, shelves, and other features may be added to backsplash sheet 302. In another example, lighting 316 may be removably attached to backsplash sheet 302. In some illustrative examples, an additional decorative sheet is optionally attached to backsplash sheet 302. In some illustrative examples, the additional decorative sheet is applied after backsplash sheet 302 is attached to the lavatory monument.

The illustrative examples shown in FIG. 3 are not meant to imply physical or architectural limitations to the manner in which an illustrative embodiment may be implemented. Other options, styles, and arrangements are also possible.

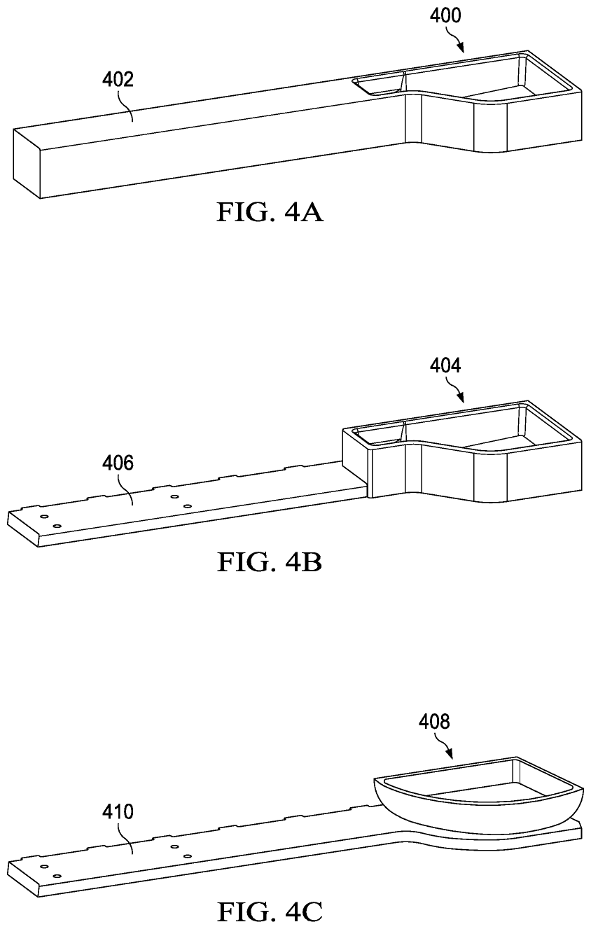

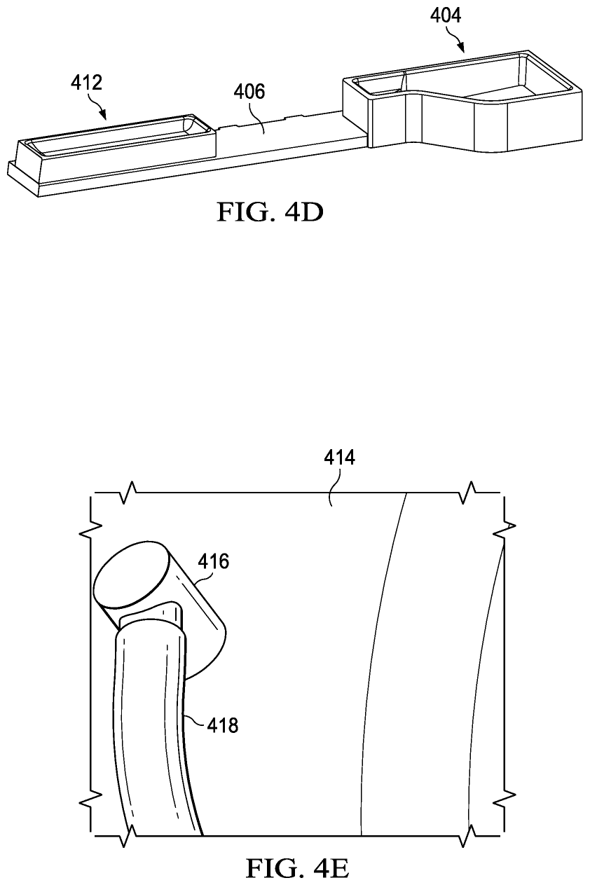

FIG. 4A through FIG. 4E are illustrations of sink and counter top options for an aircraft modular lavatory monument in accordance with an illustrative embodiment. Together, FIG. 4A through FIG. 4E may be referred to as “FIG. 4.” Each of the sinks with integral or removably attached countertops shown in FIG. 4 may be removably attached to one of the backsplash or outboard wall of aircraft modular lavatory monument 100. The sinks with integral or removably attached countertops may be implementations for modular counter system 122 of FIG. 1. In some illustrative examples, an implementation shown in FIG. 4 may be positioned beneath any desirable option of the options of FIG. 2.

FIG. 4 presents physical implementations of at least one lavatory fixture of plurality of lavatory fixtures 1714 of FIG. 17. For example, sink 400, sink 404, and sink 408 may be implementations of a lavatory fixture of plurality of lavatory fixtures 1714 of FIG. 17.

FIG. 4A illustrates sink 400 integrated monolithically with counter 402. Sink 400 may be attached to backsplash sheet 302 of FIG. 3 or modular outboard wall 102 of FIG. 1. This option may be referred-to as the integral sink bowl option.

FIG. 4B illustrates sink 404 removably attached to counter 406 at one end of sink 404. Sink 404 has a different shape than sink 400, as indicated. Sink 404 may be attached to backsplash sheet 302 of FIG. 3 or modular outboard wall 102 of FIG. 1. This option may be referred to as a raised sink bowl option.

FIG. 4C illustrates sink 408 removably attached to the top of counter 410. Sink 408 has a different shape than sink 400 or sink 404, as indicated. Sink 408 may be attached to backsplash sheet 302 of FIG. 3 or modular shell wall 106 of FIG. 1.

FIG. 4D is similar to FIG. 4B, though with different options. In particular, fixture 412 is added to counter 406. Fixture 412 may be a soap or jewelry holder, as shown, or may be a tray, a cologne rack, towel bar, shelf, or other fixture.

FIG. 4E illustrates an underside of any of the sinks shown in FIG. 4A through FIG. 4D. Backside 414 of the sink includes drain 416 and hose 418 for receiving waste water, removably attached to drain 416.

The sinks and countertops described herein may be injection molded or chopped glass fiber materials with finishes to add ascetic attractiveness. Metals, such as Aluminum, could also be used, though preferably the materials should be strong and lightweight.

The illustrative examples shown in FIG. 4 are not meant to imply physical or architectural limitations to the manner in which an illustrative embodiment may be implemented. Other options, styles, and arrangements are also possible.

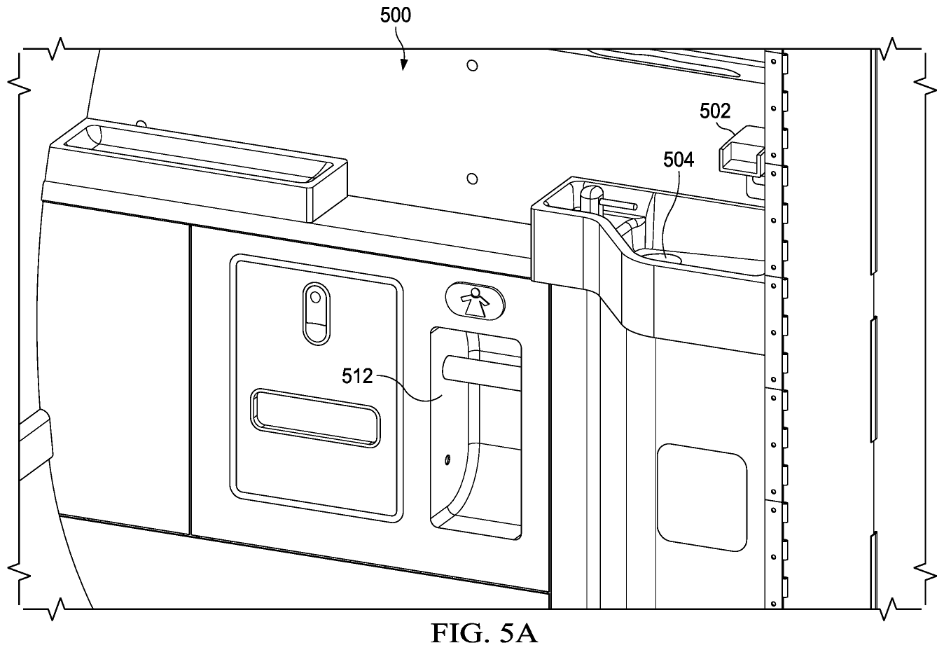

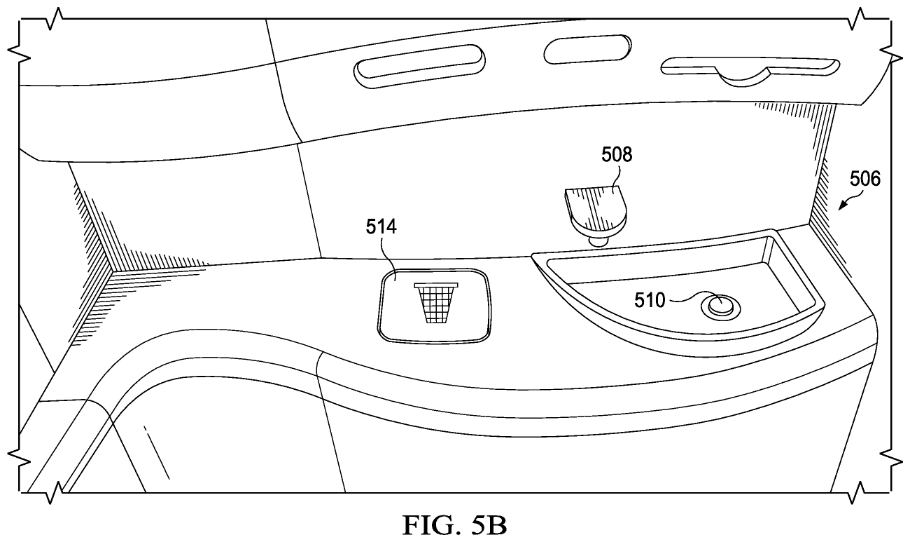

FIG. 5A and FIG. 5B are illustrations of sink and countertop options for an aircraft modular lavatory monument in accordance with an illustrative embodiment. Together, FIG. 5A through FIG. 5B may be referred to as “FIG. 5.” FIG. 5A and FIG. 5B show different backsplash, sink, and countertop arrangements. For example, in lavatory option 500 of FIG. 5A, faucet 502 is provided to one side of drain 504. However, in lavatory option 506 of FIG. 5B, faucet 508 is provided over drain 510. Different ascetic designs, patterns, and shapes are shown, as well as the location of fixtures, such as waste receptacle 512 in FIG. 5A versus waste receptacle 514 in FIG. 5B.

FIG. 5 provides a “look and feel” non-limiting example of the inside an aircraft modular lavatory monument, such as aircraft modular lavatory monument 100. FIG. 5 provides physical implementations of plurality of lavatory fixtures 1714 of lavatory monument 1704 of FIG. 17. However, other options, styles, and arrangements are also possible. The illustrative examples shown in FIG. 5 are not meant to imply physical or architectural limitations to the manner in which an illustrative embodiment may be implemented.

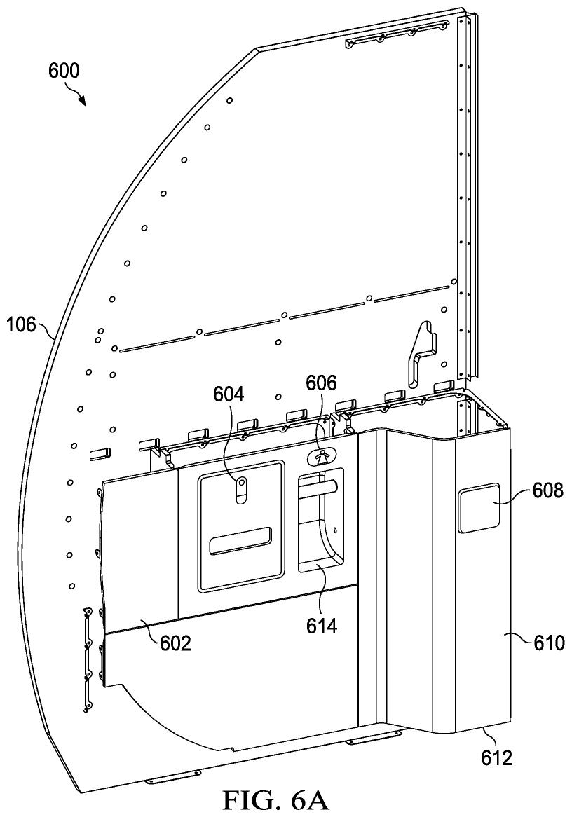

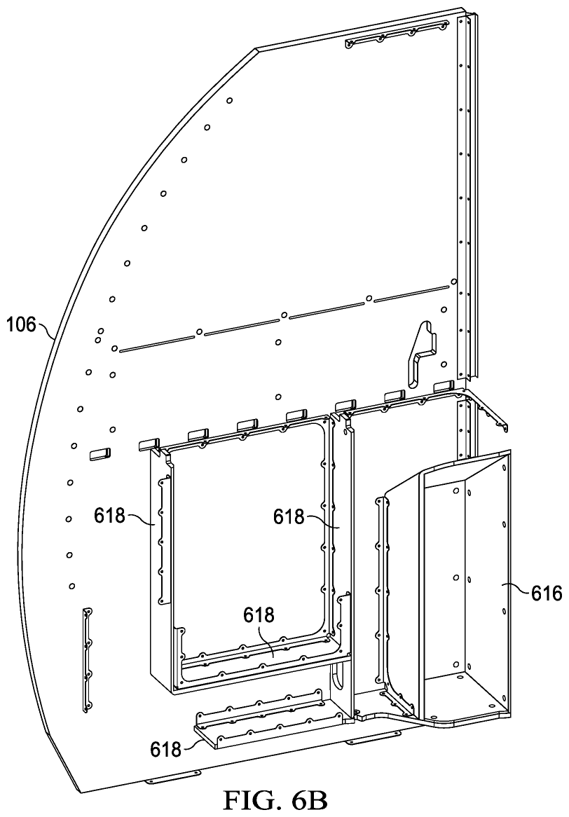

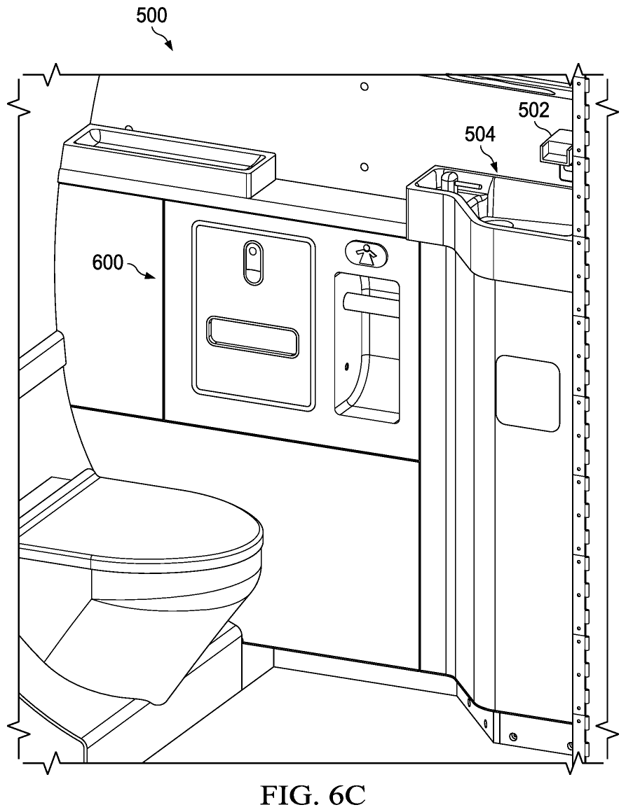

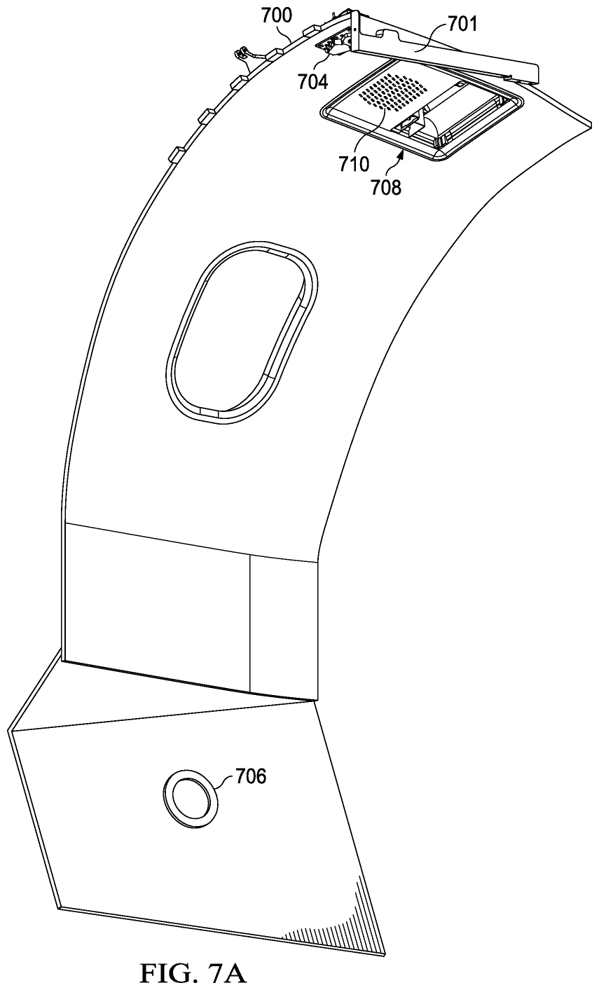

FIG. 6A through FIG. 6C are illustrations of lower storage and wall options for an aircraft modular lavatory monument in accordance with an illustrative embodiment. Together, FIG. 6A through FIG. 6C may be referred to as “FIG. 6”. The features shown in FIG. 6 are ultimately mounted to modular shell wall 106 of FIG. 1.

Turning now to FIG. 6A, lower cabinet assembly 600 is depicted mounted to modular shell wall 106. In FIG. 6A, lower cabinet assembly 600 is depicted without an upper cabinet assembly, backsplash, or counter. Lower cabinet assembly 600 is one non-limiting example of a lower cabinet assembly that may be present in lavatory monument 1704 of FIG. 17.

Lower cabinet assembly 600 includes one and preferably several options mounted to modular shell wall 106. For example, lower cabinet assembly 600 may include drawer 602 for additional storage. Lower cabinet assembly 600 may also include tissue or airsick bag dispenser 604. Lower cabinet assembly 600 may also include attendant call switch or display sign 606.

Lower cabinet assembly 600 may also include waste containment flap 608, which may be either manually actuated (pushed about a hinge or actuated with a foot pedal) or automatically actuated using a sensor in conjunction with a motor on waste containment flap 608. Lower cabinet assembly 600 may also include waste containment door 610 so that a waste receptacle disposed on the other side of waste containment door 610 can be maintenance.

Lower cabinet assembly 600 may also include floor lights 612, which may be provided in a variety of different colors and optionally may change colors during particular phases of flight or at the option of the operator. Lower cabinet assembly 600 may also include toilet paper dispenser 614.

FIG. 6B illustrates mounting fixtures for mounting the various components shown for lower cabinet assembly 600 of FIG. 6A. Thus, for example, box 616 may hold the waste receptacle on the other side of waste containment door 610. Mounting beams 618 may be used to removably attach the various other components described with respect to FIG. 6A. These features allow for easy removeable attachment of the various fixtures shown in FIG. 6A. Mounting beams 618 provide for ease of removal and replacement of the various fixtures shown in FIG. 6A or any other fixtures having the common interface points.

FIG. 6B also illustrates the usefulness of providing modular shell wall 106 in addition to ballistic intrusion barrier 108 of FIG. 1, and may be one of several features which are provided because of the heavy regulatory environment of aircraft lavatory monuments. By using modular shell wall 106 as an adapter panel, it is possible to eliminate a number of ballistic inserts from the ballistic wall panel, which provides cost and weight savings while maintaining the regulatory need for, in some aircraft designs, ballistic intrusion barrier 108.

The illustrative embodiments are not necessarily limited to the options shown in FIG. 6B. Other features that may be added include, but are not limited to: a water heater; an actuated faucet supply valve; a temperature mix valve; an automatic drain valve; a water supply shutoff valve; and a water system drain valve. This valve may be included because the supply for the lavatory monument comes from above, and extends down below the faucet height for the toilet. A separate run to a drain port on the skin is included on the airframe in order to drain the supply line, as removal of the monument would require draining the supply line.

Other features that may be added include a water supply lines; a gray water drain line; sloped plumbing as required by aircraft regulations; a fire extinguisher; a water filter; and others.

FIG. 6C illustrates one arrangement for lower cabinet assembly 600 shown in FIG. 6A, as it would appear to a user entering the lavatory monument. FIG. 6C provides a “look and feel” non-limiting example of the inside of an aircraft modular lavatory monument, such as aircraft modular lavatory monument 100 of FIG. 1. FIG. 6C is a view of lower cabinet assembly 600 with faucet 502 is provided to one side of drain 504 as in lavatory option 500 of FIG. 5A. Lower cabinet assembly 600 may be used with any desirable backsplash, counter, or any other desirable lavatory fixtures.

FIG. 6 provides physical implementations of plurality of lavatory fixtures 1714 of lavatory monument 1704 of FIG. 17. Other options, styles, and arrangements are also possible. The illustrative examples shown in FIG. 6 are not meant to imply physical or architectural limitations to the manner in which an illustrative embodiment may be implemented.

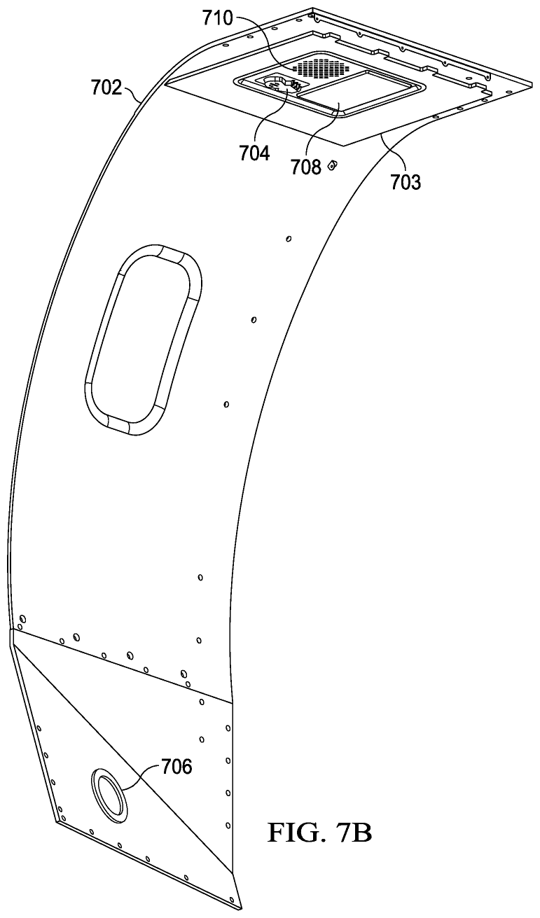

FIG. 7A and FIG. 7B are illustrations of outboard wall and ceiling options for an aircraft modular lavatory monument in accordance with an illustrative embodiment. Together, FIG. 7A and FIG. 7B may be referred to as “FIG. 7.”

Outboard wall 700 and outboard wall 702 may be variations of modular outboard wall 102 of FIG. 1. Outboard wall 700 and outboard wall 702 may be physical implementations of outboard wall 1706 of FIG. 17.

Outboard wall 700 and outboard wall 702 have different shapes to accommodate different aircraft, as shown. Different features may also be provided. For example, outboard wall 700 may include machined door header 701, whereas outboard wall 702 includes ceiling panel 703. Smoke detector 704 may be included on one or both of the outboard wall designs.

These outboard walls may include different options. For example, the following may be provided: a virtual window; a corner handle; a diaper changing table; a shelf; a speaker (hidden or otherwise); an oxygen dispenser; a toilet seat covers integrated into modular shell wall 106 of FIG. 1; a ceiling or wall light; and others. For example, as depicted, outboard wall 700 and outboard wall 702 each have systems panel 708. In some illustrative examples, systems panel 708 provides speaker 710.

FIG. 7 also illustrates the unique regulatory environment in which aircraft modular lavatory monument 100 is produced. For example, all orifices for receiving wires and fluid lines need to be sealed and/or blanketed for fire containment per governmental regulations. Additionally, aircraft modular lavatory monument 100, and therefore outboard wall 700 and outboard wall 702 are provided with aircraft umbilical interface point 706 such that aircraft modular lavatory monument 100 may be integrated with the fluid and electrical systems of the aircraft as a whole.

Other options, styles, and arrangements are also possible. The illustrative examples shown in FIG. 7 are not meant to imply physical or architectural limitations to the manner in which an illustrative embodiment may be implemented.

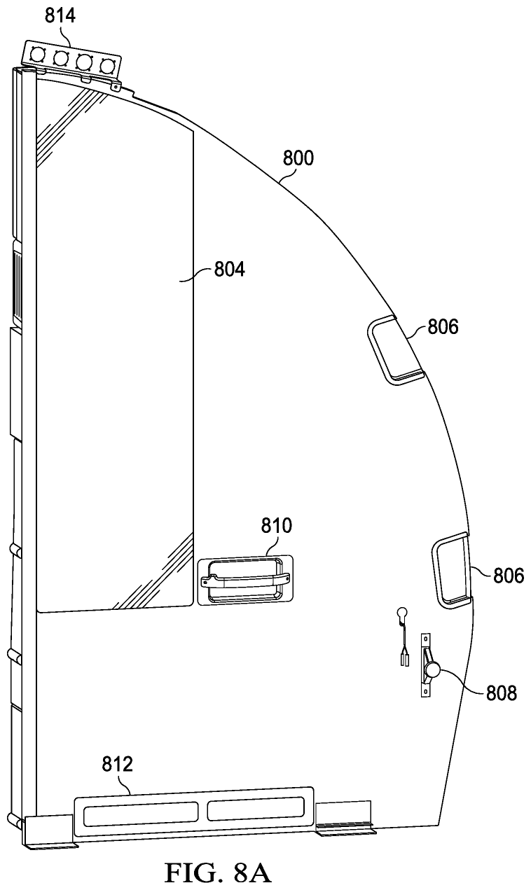

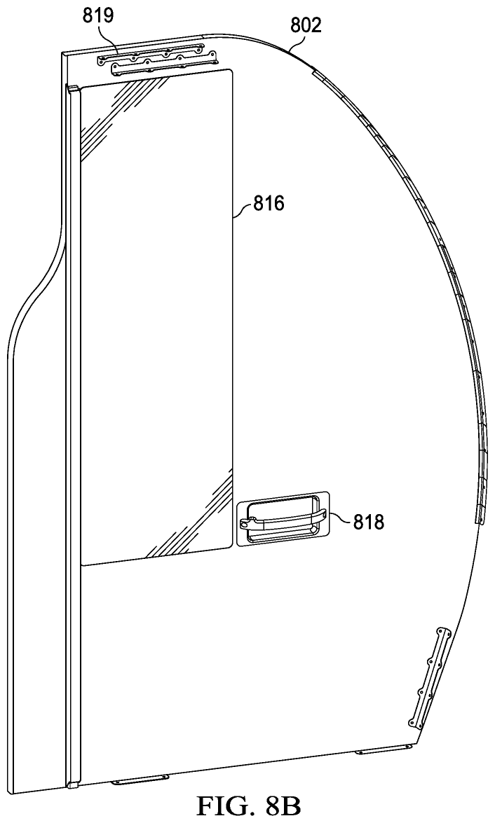

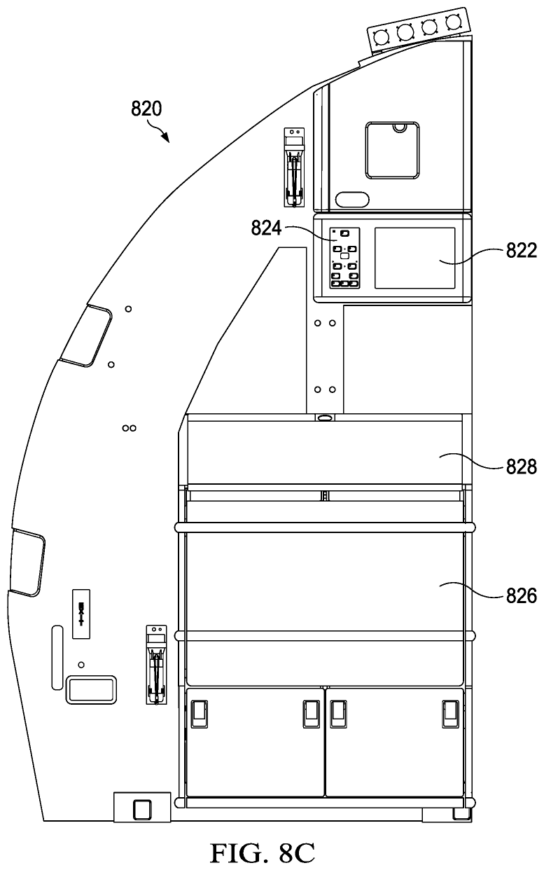

FIG. 8A through FIG. 8C are illustrations of aft wall options for an aircraft modular lavatory monument in accordance with an illustrative embodiment. In particular, aft wall 800, aft wall 802, and aft wall 820 may be modular aft wall 110 of FIG. 1. Together, FIG. 8A through FIG. 8C may be referred to as “FIG. 8.” Aft wall 800, aft wall 802, and aft wall 820 may be physical implementations of aft wall 1720 of FIG. 17.

As depicted, aft wall 800 of FIG. 8A is an implementation of an aft wall adjacent an aircraft entry door. View of aft wall 800 of FIG. 8A is an interior view within a lavatory, such as aircraft modular lavatory monument 100 of FIG. 1. Aft wall 800 includes mirror 804, aircraft door flaps 806 and vent 808 for providing heated air. Aircraft door flaps 806 in aft wall 800 allow aircraft door snubbers to pass through aft wall 800 when the aircraft entry door is opened.

Also provided are assist handle 810, lighting panels 812, and attachment flange 814 for attaching aft wall 800 to a fuselage within an aircraft, such as fuselage 1702 of aircraft 1700.

As depicted, aft wall 802 of FIG. 8B is an implementation of an aft wall of a lavatory that is not adjacent to an aircraft entry door. For example, aft wall 802 may be within a lavatory in the center or the rear of the cabin of an aircraft, such as aircraft 1700 of FIG. 17. View of aft wall 802 in FIG. 8B is an interior view within a lavatory, such as aircraft modular lavatory monument 100 of FIG. 1. Aft wall 802 includes mirror 816 and assist handle 818. Attachment feature 819, in this illustrative embodiment, does not extend the height of the aft wall, as is the case with attachment flange 814 in FIG. 8A.

As depicted, aft wall 820 of FIG. 8C is an implementation of an aft wall of a lavatory that is adjacent to an aircraft entry door. View of aft wall 820 in FIG. 8C is a view of aft wall 820 outside of a lavatory, such as aircraft modular lavatory monument 100 of FIG. 1. For example, aft wall 820 may be an implementation of an exterior of aft wall 800 of FIG. 8A. View of aft wall 820 may be the side of aft wall 820 visible to passengers upon entering an aircraft, such as aircraft 1700 of FIG. 17. View of aft wall 802 in FIG. 8B is an interior view within a lavatory, such as aircraft modular lavatory monument 100 of FIG. 1. Aft wall 820 includes many features, including cabinetry as shown. Also shown is display screen 822, user interface 824, and other features which may be provided as described elsewhere herein.

In some illustrative embodiments, the aft wall is provisioned for a large number of interfaces, including attendant seats, such as foldable attendant seat 826. It is desirable for aft walls, such as aft wall 820, to be designed in terms of shape and materials to hold high loads due to attendant seats and other equipment interfaces. Conventional attendant seat plug and sleeve inserts would undesirably be seen from the inside of the lavatory. The aft wall, such as aft wall 800, aft wall 802, or aft wall 820, may have imbedded foam kits and metal details to deal with wire pass throughs and attendant seat mounting.

It is also desirable for an aircraft electrical umbilical to route through the aft wall, so wiring clamshells may be provided in the aft wall. The aft wall may be provided with the aircraft electrical umbilical interface for the lavatory.

Thus, FIG. 8 shows that the aft wall may include a number of different features. The aft wall may be provided with floor fittings. An assist handle may be provided. A foldable diaper changing table 828 may be provided. In some illustrative examples, the aft wall may be provided with an ECS routing for a door heat grille.

Other options, styles, and arrangements are also possible. The illustrative examples shown in FIG. 8 are not meant to imply physical or architectural limitations to the manner in which an illustrative embodiment may be implemented.

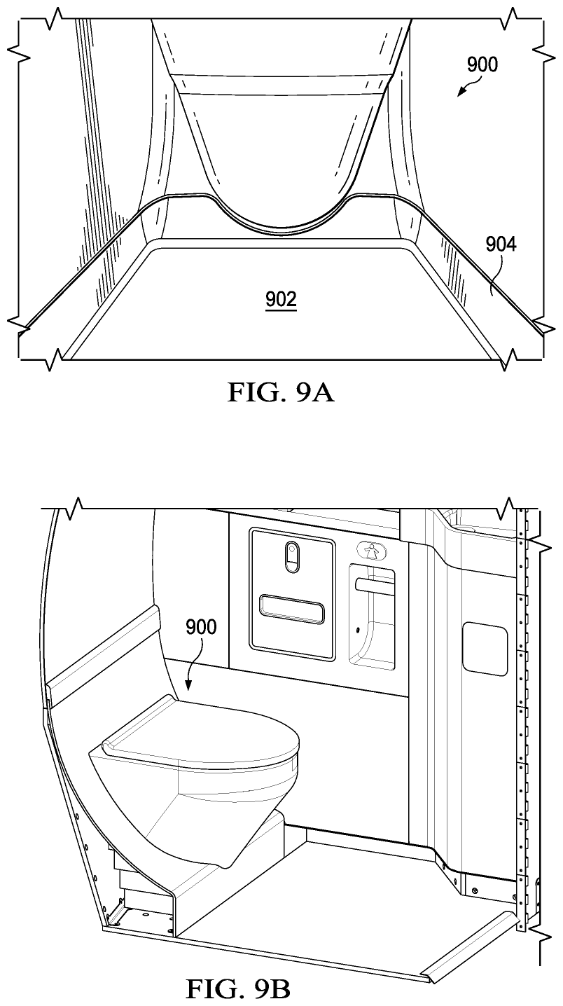

FIG. 9A and FIG. 9B are illustrations of toilet shroud options for an aircraft modular lavatory monument in accordance with an illustrative embodiment. FIG. 9A and FIG. 9B may be examples of toilet shroud 114 of aircraft modular lavatory monument 100 of FIG. 1. Together, FIG. 9A and FIG. 9B may be referred to as “FIG. 9”. FIG. 9A is a top-down view of the toilet shroud 900. FIG. 9B is a perspective view of toilet shroud 900. Toilet shroud 900 and floor pan 902 provide examples of one possible “look and feel” of the toilet shroud and lavatory of the illustrative embodiments described herein. Toilet shroud 900 and floor pan 902 are physical implementations of toilet shroud 1712 and floor pan 1728 of FIG. 17.

In some illustrative examples, additional structural features are present. For example, toilet shroud 900 may be provided with at least one of electronic latches or a tamper indication system.

As depicted, toilet shroud 900 is a one-piece toilet shroud. Having a one-piece toilet shroud reduces the number of sealing areas for toilet shroud 900. Toilet shroud 900 is designed and manufactured with materials selected to resist wear and tear. Toilet shroud 900 is designed and manufactured with a shape and materials selected based on at least one of manufacturability, aesthetics, ease of cleaning, or other desirable characteristics. Manufacturing a one-piece toilet shroud may use a large manufacturing pressure within a mold or press.

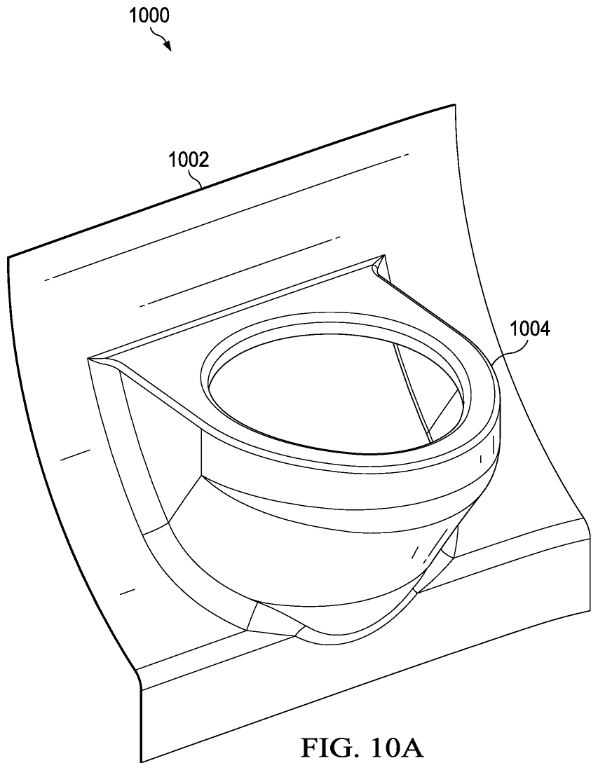

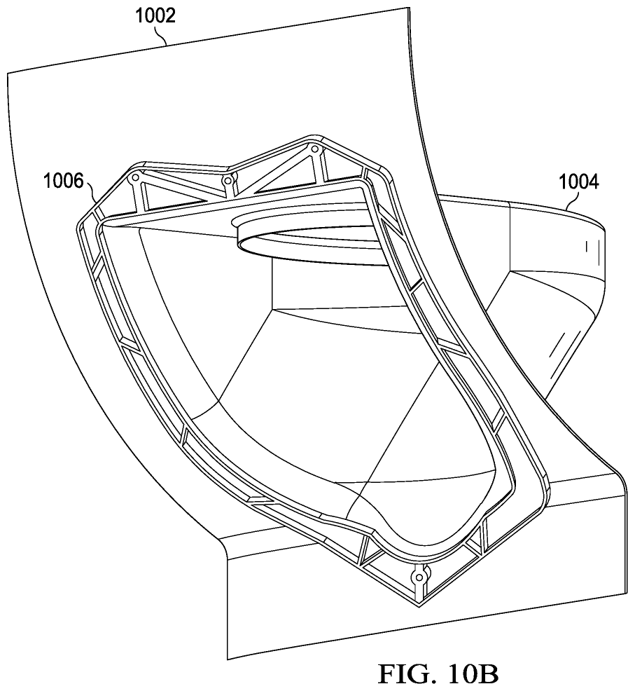

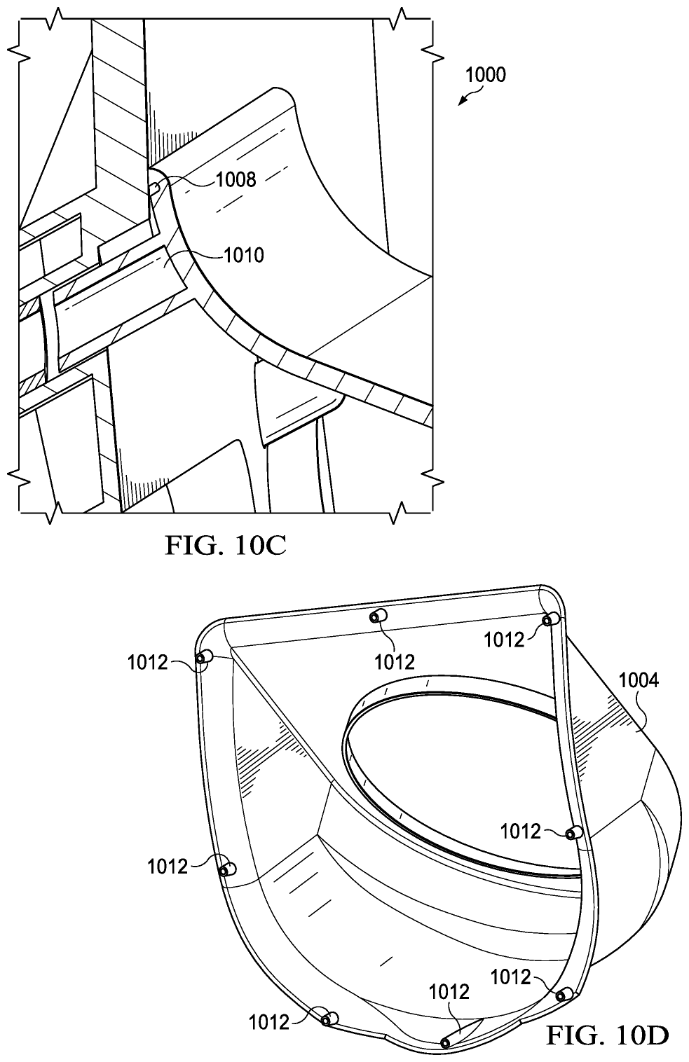

While toilet shroud 900 is shown as being a monolithic shroud, in other illustrative examples, a toilet shroud may be formed of any desirable quantity of pieces. In some illustrative examples, a three-piece shroud may be used. Manufacturing a three-piece toilet shroud reduces the manufacturing pressure in a press. Increasing the quantity of pieces for toilet shroud 900 would also increase the quantity of sealing areas. A three-piece toilet shroud arrangement is shown in FIG. 10A through FIG. 10D.

Floor pan 902 includes interface 904 between floor pan 902 and toilet shroud 900. Floor pan 902 is desirably easily removable and replaceable. Floor pan 902 is configured to easily allow floor fitting access in final assembly.

Materials for toilet shroud 900 and floor pan 902 are selected based on at least one of manufacturability, weight, cost, or ease of cleaning. Toilet shroud 900 and floor pan 902 will have high customer exposure in an aircraft. A thermoformed plastic is a useful material for floor pan 902.

In some illustrative examples, floor pan 902 is provided with weep holes to allow water leaks behind toilet shroud 900 to be detected. Floor pan 902 must be sealed up to 4″ around the floor of the lavatory, per government regulations.

Other options, styles, and arrangements are also possible. Therefore, the illustrative examples shown in FIG. 9 are not meant to imply physical or architectural limitations to the manner in which an illustrative embodiment may be implemented.

FIG. 10A through FIG. 10D are illustrations of toilet shroud options for an aircraft modular lavatory monument in accordance with an illustrative embodiment. FIG. 10A through FIG. 10D may be examples of toilet shroud 114 of aircraft modular lavatory monument 100 of FIG. 1. Together, FIG. 10A through FIG. 10D may be referred to as “FIG. 10”. These figures describe the three-piece shroud arrangement mentioned in FIG. 9. FIG. 10 presents physical implementations of toilet shroud 1712 and floor pan 1728 of FIG. 17.

Toilet shroud 1000 includes three pieces, including panel 1002, bowl shroud 1004, and backing plate 1006. Backing plate 1006 is used to reinforce and secure the attachment of bowl shroud 1004 to panel 1002. The panel 1002 may be clamped between backing plate 1006 and bowl shroud 1004 when fasteners therebetween are tightened.

Each of panel 1002, bowl shroud 1004, and backing plate 1006 is formed of any desirable material. In some illustrative examples, panel 1002 is formed of a different material than either bowl shroud 1004 or backing plate 1006. In some illustrative examples, bowl shroud 1004 and backing plate 1006 are formed of molded polymeric materials. In some illustrative examples, panel 1002 is formed of a composite sandwich material. In some illustrative examples, panel 1002 is formed of a crush core fiberglass panel.

FIG. 10C shows a cross-section of toilet shroud 1000 in order to show the connection between bowl shroud 1004 and panel 1002. In particular, sealant slot 1008 is filled with a material, such as silicone, so that the flange flexes slightly as fasteners are tightened for a comprehensive fit on to panel 1002.

As depicted, insert 1010 is provided in bowl shroud 1004. In some illustrative examples, insert 1010 is a threaded metal insert. Insert 1010 is configured to receive a fastener. Insert 1010 increases the strength of connections between bowl shroud 1004 and backing plate 1006. Insert 1010 may aid in the repeatability of assembly and disassembly. Insert 1010 may be installed through heating or ultrasonic installation.

In some other illustrative examples, fasteners extend through backing plate 1006 and are tightened directly into bowl shroud 1004. In these illustrative examples, insert 1010 is not present.

FIG. 10D illustrates a back view of the bowl shroud 1004, along with connection points 1012 that are used to connect bowl shroud 1004 to backing plate 1006. In FIG. 10D, bowl shroud 1004 is not yet attached to panel 1002 or backing plate 1006. In some illustrative examples, each of connection points 1012 includes a metal insert, such as insert 1010.

Other options, styles, and arrangements are also possible. The illustrative examples shown in FIG. 10 are not meant to imply physical or architectural limitations to the manner in which an illustrative embodiment may be implemented.

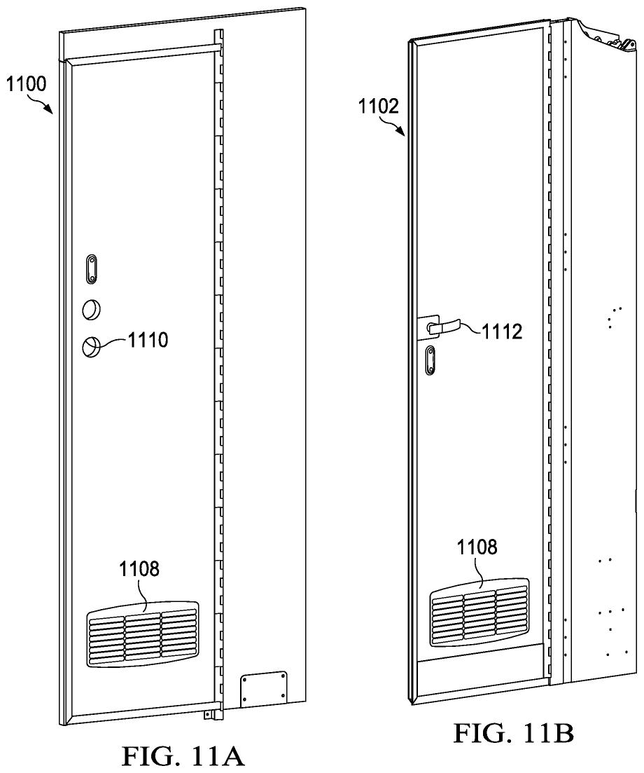

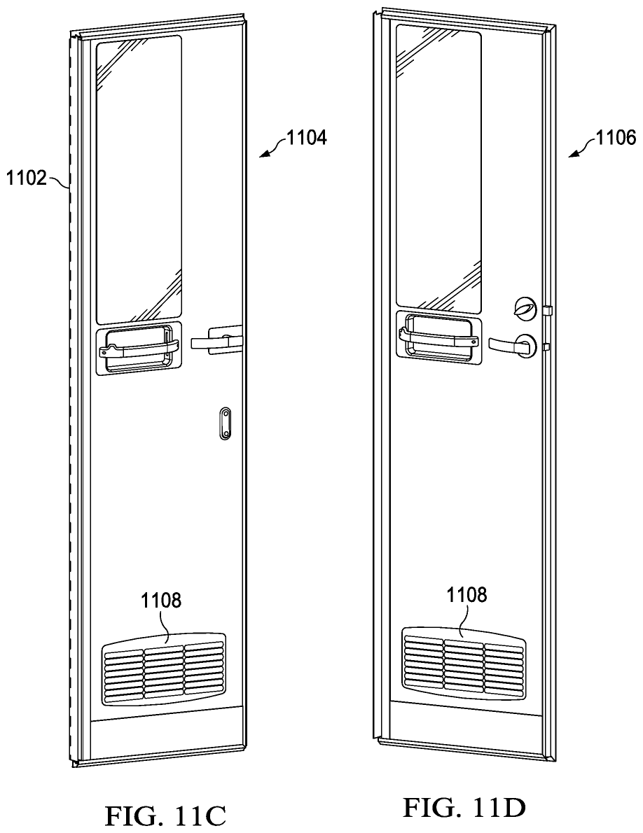

FIG. 11A through FIG. 11D are illustrations of door options for an aircraft modular lavatory monument in accordance with an illustrative embodiment. Together, FIG. 11A through FIG. 11D may be referred to as “FIG. 11”. Door 1100, door 1102, door 1104, and door 1106 may be examples of modular door 118 of FIG. 1. Door 1100, door 1102, door 1104, and door 1106 may be physical implementations of door 1724 of FIG. 17.

Door 1100, door 1102, and door 1104 all show different door arrangements and features, any of which could be removably attached to a particular aircraft lavatory monument. Door 1106 illustrates a specific illustrative embodiment which shows a possible “look and feel” of a particular door design.

As depicted, each of the doors, door 1100, door 1102, door 1104, and door 1106, includes vent 1108 to allow air exchange between the inside of the aircraft lavatory monument and the rest of the interior of the fuselage of the aircraft. Vent 1108 may be sized, dimensioned, and designed to prevent flame from exiting the lavatory. In some illustrative examples, vent 1108 includes two louvre assemblies. In these illustrative examples, the louvres are configured to create a “tortuous path.” The “tortuous path” reduces or eliminates flame paths through vent 1108. In some illustrative examples, a screen is sandwiched between the two louvre assemblies. The screen is configured to provide additional flame containment. In some illustrative examples, the louvre assemblies are mirror images of each other about the screen.

In FIG. 11A, a handle is not present in door 1100. In FIG. 11A, holes 1110 are visible. Holes 1110 may be provided so that a door handle, such as door handle 1112, may be easily removably attached to the door.

FIG. 11A and FIG. 11B are views from an exterior of a modular aircraft lavatory monument. FIG. 11A and FIG. 11B are examples of the exterior side of doors that may be viewed from within a cabin of an aircraft. FIG. 11C and FIG. 11D are views from an interior of a modular aircraft lavatory monument. FIG. 11C and FIG. 11D are examples of an “interior” side of doors that are not visible within the cabin when the door is closed.

Additional features may be provided. For example, mirror 1114, assist handle 1116, ashtray 1118, or additional features may be added. For example, the door may be a power door. Lighting may be provided for the latch or assist handle. Edge potted inserts may be provided.

Although each of door 1100, door 1102, door 1104, and door 1106 is depicted as a slab door with a single hinge, a door for an aircraft modular lavatory monument may take any desirable form. The door may be a bifold door, a pocket door, a multiply hinged door, or other type of door. The door may be provided with a lock override so that staff can enter a locked lavatory to assist a person in need. An illuminated occupancy indication light may be provided. A limit switch and sensor may be present to so that a display or sign can indicate when the door is open, closed, or locked. The door may be provided with pinchless hinges.

Other options, styles, and arrangements are also possible. The illustrative examples shown in FIG. 11 are not meant to imply physical or architectural limitations to the manner in which an illustrative embodiment may be implemented.

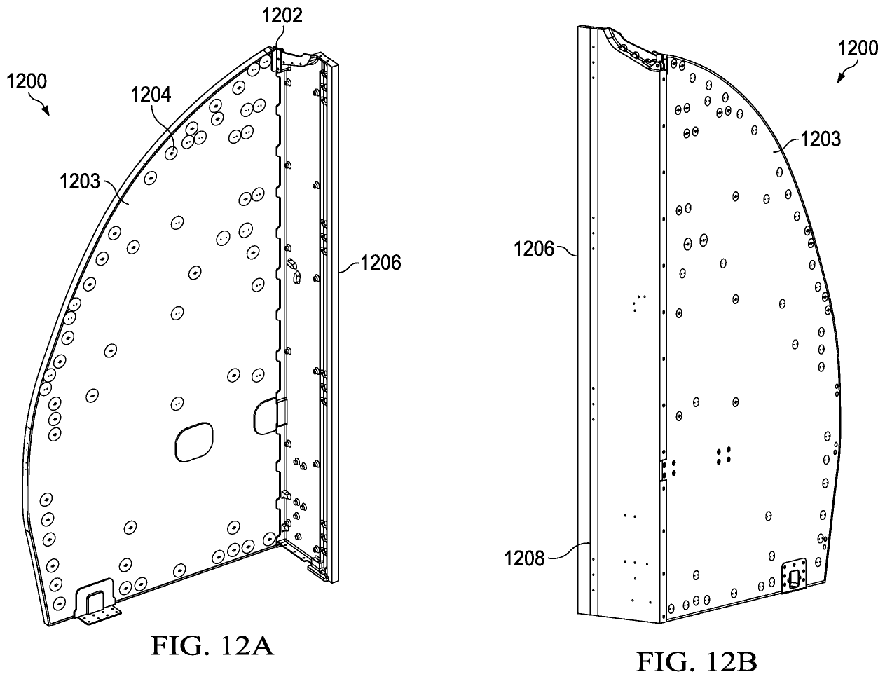

FIG. 12A and FIG. 12B are illustrations of ballistic intrusion barrier options for an aircraft modular lavatory monument in accordance with an illustrative embodiment. Together, FIG. 12A and FIG. 12 may be referred to as “FIG. 12”. FIG. 12A and FIG. 12B illustrate different sides of the same ballistic intrusion barrier. Ballistic intrusion barrier 1200 may be ballistic intrusion barrier 108 of FIG. 1. In some illustrative examples, ballistic intrusion barrier 1200 may be referred to as a ballistic barrier, ballistic barrier wall, or a ballistic intrusion barrier wall.

Ballistic intrusion barrier 1200 is an optional component present in selected lavatory monuments. Ballistic intrusion barrier 1200 may be used in lavatory monuments in the front of a passenger cabin in an aircraft.

Ballistic intrusion barrier 1200 may include shield 1202, which may be formed from titanium or other ballistically resistant material, including ceramics, honey-combed layered composite materials, and others. Shield 1202 of ballistic intrusion barrier 1200 is joined to panel 1203. Panel 1203 is formed of any desirable ballistically resistant material. In some illustrative examples, panel 1203 is formed of layers of aramid fibers. Ballistic inserts, such as ballistic insert 1204, extend through panel 1203. Ballistic inserts provide connection points for joining structures to panel 1203. Ballistic inserts provide additional shielding in locations where fasteners extend through panel 1203. In some illustrative examples, ballistic inserts provide additional shielding in the form of a metal plate of the ballistic insert.

Ballistic intrusion barrier 1200 also comprises side wall 1206. Side wall 1206 is formed of titanium or any desirable ballistically resistant material. Side wall 1206 may be provided with a door hinge interface 1208 in some illustrative embodiments.

Other options, styles, and arrangements are also possible. The illustrative examples shown in FIG. 12 are not meant to imply physical or architectural limitations to the manner in which an illustrative embodiment may be implemented.

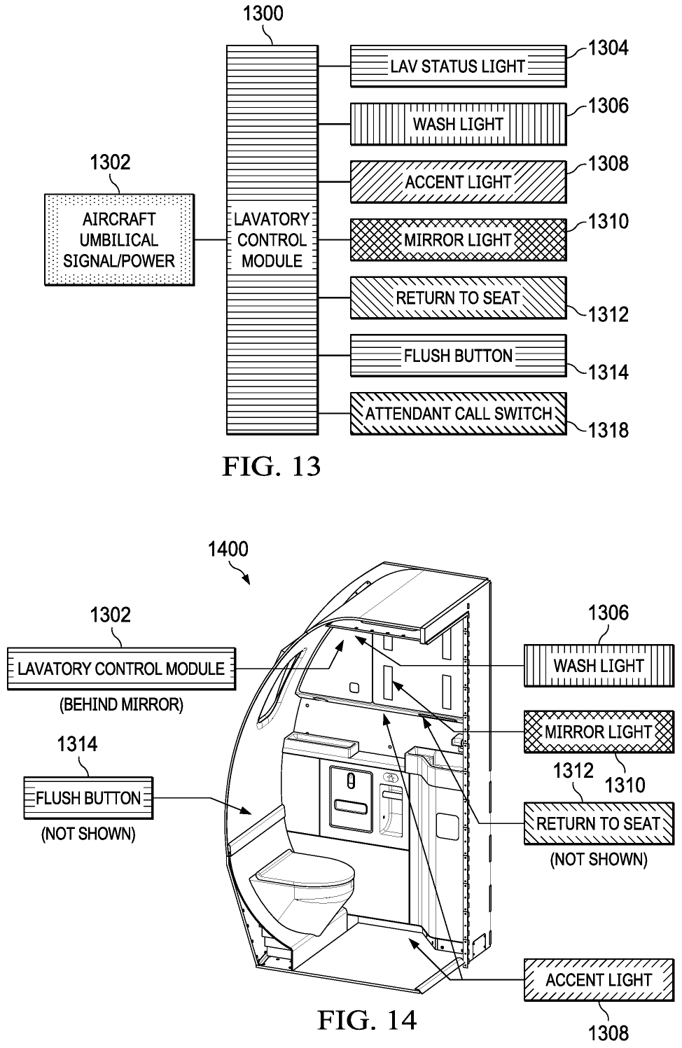

FIG. 13 is an illustration of a block diagram of a lighting system for an aircraft modular lavatory monument in accordance with an illustrative embodiment. Lavatory control module 1300 may be attached to any of the walls or ceiling of aircraft modular lavatory monument 100 of FIG. 1. Lavatory control module 1300 connects to aircraft electrical umbilical 1302, which provides signals, power, and possibly fluid lines to aircraft modular lavatory monument 100. Lavatory control module 1300 may be one or more computers or application specific integrated circuits.

Lavatory control module 1300 may control various aspects of the lighting for aircraft modular lavatory monument 100. For example, lavatory control module 1300 may control lavatory status lights 1304. These may be variously colored lights, such as but not limited to red, green, and amber, that indicate lavatory occupancy or the status of an attendant call.

In another example, lavatory control module 1300 may control wash lights 1306. These lights may be high lumen lights to serve as the primary light source for aircraft modular lavatory monument 100. A variety of colors, possibly variable colors, may be provided. Such lights can be mounted in the ceiling, upper cabinet, or walls of aircraft modular lavatory monument 100.

In yet another example, lavatory control module 1300 may control accent lights 1308. Accent lights include countertop lights, backsplash lights, and/or kick accent lighting. A variety of colors, possibly variable colors, may be provided.

In still another example, lavatory control module 1300 may include mirror lights 1310. Mirror lights are preferably soft, warm lights that shine through or on the mirror such that a person's face is illuminated when looking in the mirror. The terms “soft” and “warm” are understood by the ordinary artisan, such as for example as described on the product labels of commercially available lights.

In another illustrative embodiment, lavatory control module 1300 may include return to seat sign 1312. This sign may be a light emitting diode (LED) that may shine through the mirror, or may be located elsewhere in aircraft modular lavatory monument 100. The control logic for this sign is preferably transferred through aircraft electrical umbilical 1302 into lavatory control module 1300 to return to seat sign 1312.

In still another illustrative embodiment, lavatory control module 1300 may include flush button 1314. This button may be a light emitting diode that illuminates and thus easily identifies the button used to actuate flushing of the toilet.

In yet another illustrative embodiment, lavatory control module 1300 may include attendant call switch 1318. This switch may be a light emitting diode that illuminates when pushed and turns off with the lavatory status switch.

Other options, styles, and arrangements are also possible. The illustrative examples shown in FIG. 13 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

FIG. 14 is an illustration of an arrangement of lights for a lighting system for an aircraft modular lavatory monument in accordance with an illustrative embodiment. Lavatory 1400 may be an example of the “look and feel” of the inside of an actual aircraft lavatory monument. Lavatory 1400 also shows possible locations for the various components shown in FIG. 13. Thus, for example, lavatory control module 1300, wash light 1306, accent lights 1308, mirror lights 1310, return to seat sign 1312, and flush button 1314 may be located as shown in FIG. 14. Lavatory 1400 may be the same as aircraft modular lavatory monument 100 of FIG. 1. Lavatory 1400 is a physical implementation of lavatory monument 1704 of FIG. 17.

Other options, styles, and arrangements are also possible. The illustrative examples shown in FIG. 14 are not meant to imply physical or architectural limitations to the manner in which an illustrative embodiment may be implemented.

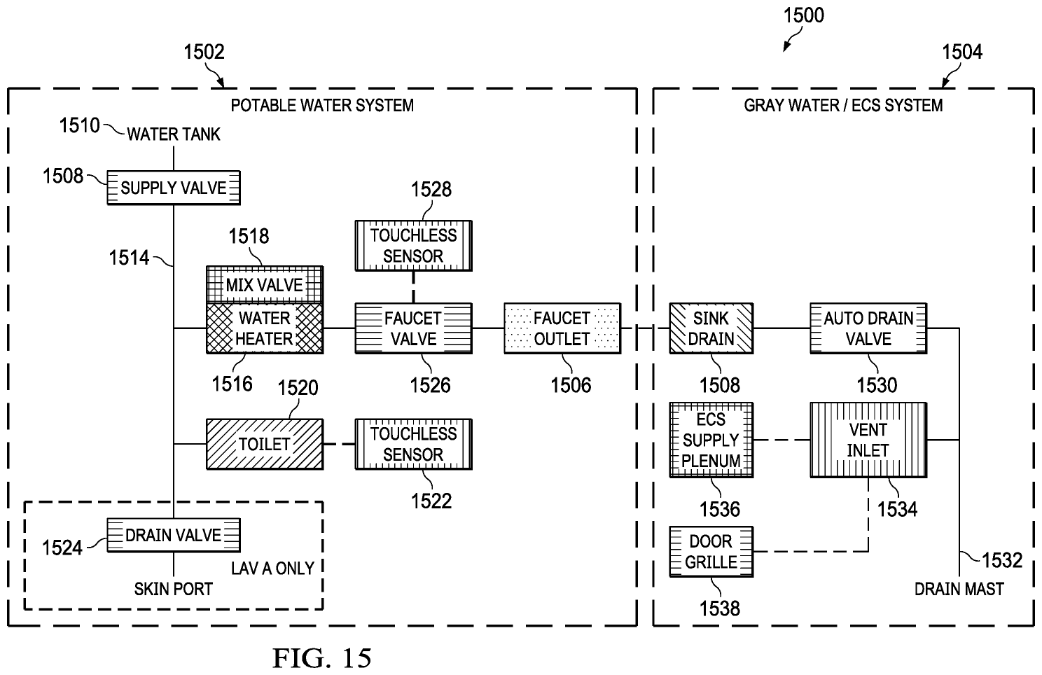

FIG. 15 is an illustration of a block diagram of a water system for an aircraft modular lavatory monument in accordance with an illustrative embodiment. Water system 1500 includes various components for controlling the flow of water into and out of an aircraft modular lavatory monument, such as that shown in FIG. 1. Water system 1500 includes various components for controlling the flow of water into and out of lavatory monument 1704 of FIG. 17.

Water system 1500 may have two almost entirely separate sub-systems, specifically potable water system 1502 and gray water system 1504. These two systems do not interact, except that faucet outlet 1506 (drain) of the potable water system 1502 drains into a common water line with sink drain 1508 of the gray water system 1504.

Water system 1500 also includes supply valve 1510, which governs the supply of water from water tank 1512 into water line 1514. Water line 1514 connects to water heater 1516 via optionally mix valve 1518. Water line 1514 also connects to toilet 1520, which is controlled by touchless sensor 1522. Optionally, water line 1514 may connect to drain valve 1524.

Water heater 1516 may connect to faucet valve 1526, which is controlled by touchless sensor 1528. Faucet valve 1526 empties into faucet outlet 1506 into sink drain 1508 of gray water system 1504.

As indicated above, gray water system 1504 includes sink drain 1508. Sink drain 1508 connects to auto drain valve 1530, which in turn empties into drain mast 1532, where waste water is stored for disposal by a ground crew during ground maintenance. Optionally, vent inlet 1534 may also empty into drain mast 1532. Optionally, ECS supply plenum 1536 and door grille 1538 may be connected to vent inlet 1534.

Other options, styles, and arrangements are also possible. The illustrative examples shown in FIG. 15 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

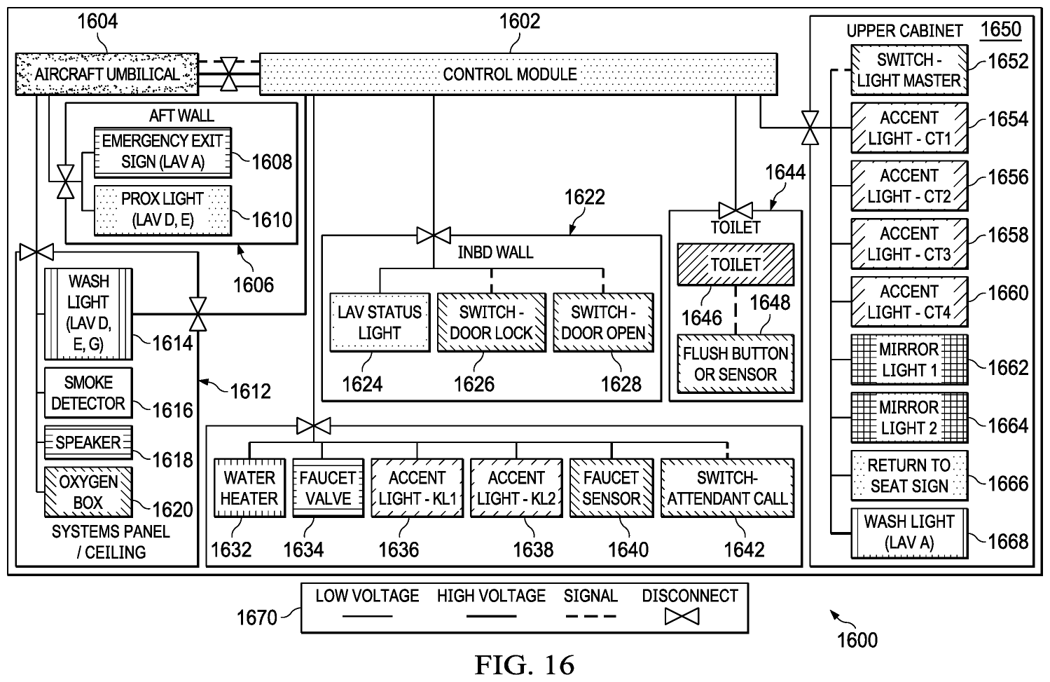

FIG. 16 is an illustration of a block diagram for a control system for an aircraft modular lavatory monument in accordance with an illustrative embodiment. Control system 1600 is a variation of the control system described above with respect to FIG. 13 and FIG. 14.

Control system 1600 includes control module 1602, which connects to aircraft electrical umbilical 1604, as well as the sub-components of control system 1600. Control module 1602 may be an implementation of control module 1738 of FIG. 17. These sub-components are arranged in groups, as shown, so that each group may be easily replaced as a unit.

For example, aft wall sub-component 1606 is connected to both control module 1602 and aircraft electrical umbilical 1604. Aft wall sub-component 1606 includes emergency exit sign 1608 and possible proximity light 1610.

In another example, system panel/ceiling sub-component 1612 is connected to control module 1602 as well as aircraft electrical umbilical 1604. System panel/ceiling sub-component 1612 includes wash light 1614, smoke detector 1616, speaker 1618, and oxygen box 1620.

In yet another example, inboard wall sub-component 1622 is connected to control module 1602. Inboard wall sub-component 1622 includes lavatory status light 1624, switch-door lock 1626, and switch-door open 1628.

In still another example, lower cabinet/backsplash sub-component 1630 is connected to control module 1602. Lower cabinet/backsplash sub-component 1630 includes water heater 1632, faucet valve 1634, accent light 1636, accent light 1638, faucet sensor 1640 and switch/attendant call button 1642.

In another illustrative embodiment, toilet sub-component 1644 is connected to control module 1602. Toilet sub-component 1644 includes toilet 1646 and flush button or sensor 1648. Thus, via a sensor, toilet 1646 may automatically flush when a user is sensed getting up from the toilet.

In yet another illustrative embodiment, upper cabinet sub-component 1650 may be connected to control module 1602. Upper cabinet sub-component 1650 may include switch-light manager 1652, accent light 1654, accent light 1656, accent light 1658, accent light 1660, mirror light 1662, mirror light 1664, return to seat sign 1666, and wash light 1668.

Legend 1670 is also provided in FIG. 16. The different types of lines and disconnects are thus represented as shown in legend 1670. As used herein, the term “low voltage” refers to less than five volts. The term “high voltage” refers to five volts or greater.

Other options, styles, and arrangements are also possible. Therefore, the illustrative examples shown in FIG. 16 are not meant to imply physical or architectural limitations to the manner in which an illustrative embodiment may be implemented.

FIG. 17 is an illustration of a block diagram of an aircraft with a modular lavatory monument in accordance with an illustrative embodiment. Aircraft 1700 may be, for example, aircraft 2000 of FIG. 20.

Aircraft 1700 may include fuselage 1702 and lavatory monument 1704. Lavatory monument 1704 is removably mounted inside the fuselage 1702. Lavatory monument 1704 may be referred to as a modular lavatory monument. Lavatory monument 1704 is subject to aircraft regulatory requirements. Thus, lavatory monument 1704 cannot easily import features and designs from bathrooms which were not designed specifically for an aircraft.

Lavatory monument 1704 includes an outboard wall 1706 removably connected to an inside surface of the fuselage 1702. Lavatory monument 1704 also includes shell wall 1708 removably connected to the outboard wall 1706 and extending radially inwardly relative to the fuselage 1702.

Lavatory monument 1704 also includes floor panel 1710 connected to and between the outboard wall 1706 and the shell wall 1708. Floor panel 1710 connects to a floor within fuselage 1702 of aircraft 1700. Lavatory monument 1704 also includes toilet shroud 1712 connected to the floor panel 1710.

Lavatory monument 1704 also includes plurality of lavatory fixtures 1714 individually removably attached to at least one of: the outboard wall 1706, the shell wall 1708, the floor panel 1710, or the toilet shroud 1712. Each of the plurality of lavatory fixtures 1714 is configured to be individually removable. When a lavatory fixture is “individually removable,” removal of one lavatory fixture does not require removal of any other of the plurality of lavatory fixtures. Common interface points 1716 on each of the plurality of lavatory fixtures 1714 are unchangeable with respect to the lavatory monument 1704.

Aircraft 1700 may be varied. For example, lavatory monument 1704 may also include ballistic intrusion barrier 1718 connected to the outboard wall 1706 adjacent the ballistic intrusion barrier 1718 and extending radially inwardly relative to the fuselage 1702. In another illustrative embodiment, one of the plurality of lavatory fixtures may be a toilet shroud removably attached to the toilet. In this case, the toilet shroud also connected to the outboard wall.

Other variations are possible. For example, the aircraft may be further modified such that the lavatory monument 1704 includes aft wall 1720 and plurality of non-lavatory fixtures 1722 connected to a second side of aft wall 1720. The aft wall 1720 is removably attached to outboard wall 1706 opposite shell wall 1708 and extending radially inwardly relative to fuselage 1702. A first side of aft wall 1720 faces an interior of the lavatory monument 1704. In an illustrative embodiment, plurality of non-lavatory fixtures 1722 may be one or more of the group consisting of: a computer, a display, a cabinet, a drawer, a lock-box, and an instrument panel.

Still other variations are possible. For example, the plurality of lavatory fixtures may include two or more objects selected from the group consisting of: a sink, a faucet, a cabinet, an alcove panel shaped to present an alcove inside the lavatory monument, a toilet paper holder, a drawer, a liquid hose line, a soap dispenser, a soap holder, a towel dispenser, a towel holder, a drawer, a backsplash, a waste receptacle, a counter top, a light strip, a light bulb, a lightable sign, a mirror, a display device, a speaker, a crew signal button, a switch, a panel, a cup holder, an airsick bag dispenser, a tissue dispenser, a sanitary napkin dispenser, a cologne rack, and a shelf.

In a different illustrative embodiment, lavatory monument 1704 may include door 1724 connected to shell wall 1708. Door 1724 may be one of a folding door and a slab door. Door 1724 may also include a lock 1726 which, when actuated, activates all of: locking the door, activating a no-vacancy sign displayed outside the door, and a lighting scenery scheme.

In another illustrative embodiment, lavatory monument 1704 may include floor pan 1728 removably connected to floor panel 1710 of the lavatory monument in front of the toilet. In still another illustrative embodiment, one or more of the plurality of lavatory fixtures 1714 comprises a plurality of sub-assemblies that are removably connected to a given lavatory fixture such that removal and replacement of one of the plurality of sub-assemblies does not require removal of any other of the plurality of sub-assemblies. A sub-assembly comprises any desirable set of lavatory fixtures. In one illustrative example, a sub-assembly comprises a backsplash, a faucet, and a liquid hose line. In this illustrative example, the sub-assembly may be installed and removed from the lavatory without removing any other sub-assemblies.

In still another illustrative embodiment, aircraft 1700 also includes electrical wiring system 1730. In this case, each of the plurality of lavatory fixtures 1714 that require electricity is removably connected to the electrical wiring system 1730. In this case, aircraft 1700 may also include computer 1732. In this case, the lavatory monument 1704 is removably connectable to the computer 1732 and the computer 1732 is configured to control one or both of: electrical fixtures or display fixtures in the lavatory monument 1704.

In yet another illustrative embodiment, aircraft 1700 may include air duct system 1734. In this case lavatory monument 1704 has an air duct that is removably connectable to the air duct system 1734.

In an illustrative embodiment, the plurality of lavatory fixtures 1714 includes a faucet, a fluid line, a sink, a drain, and a backsplash, wherein the faucet is removably connected to the fluid line, the fluid line is removably connected to the backsplash, the sink is removably connected to the shell wall, and the drain is removably connected to the sink. In another illustrative embodiment, the plurality of lavatory fixtures 1714 further includes lighting 1736 removably disposed underneath a counter at about foot level.

In still another illustrative embodiment, lavatory monument may include further features. For example, lavatory monument 1704 may include control module 1738 connectable to an aircraft electrical umbilical. In this case, control module 1738 may be removably connected to all or some of a variety of sub-components. The sub-components may include an upper cabinet sub-component; an inboard wall sub-component; a toilet sub-component; a lower cabinet and backsplash sub-component; a systems panel and ceiling sub-component; and an aft wall sub-component. In an illustrative embodiment, the aircraft electrical umbilical is also removably connectable to the aft wall sub-component and the systems panel and ceiling sub-component.

Other options, styles, and arrangements are also possible. The illustration of aircraft 1700 in FIG. 17 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, each of outboard wall 1706, shell wall 1708, and aft wall 1720 has common interface points. In some illustrative examples, aft wall 1720 has common interface points that do not change with different options for aft wall 1720. Additionally, each of plurality of non-lavatory fixtures 1722 has common interface points. The common interface points on each of plurality of non-lavatory fixtures 1722 provides for ease of removal and replacement of sub-assemblies connected to aft wall 1720.

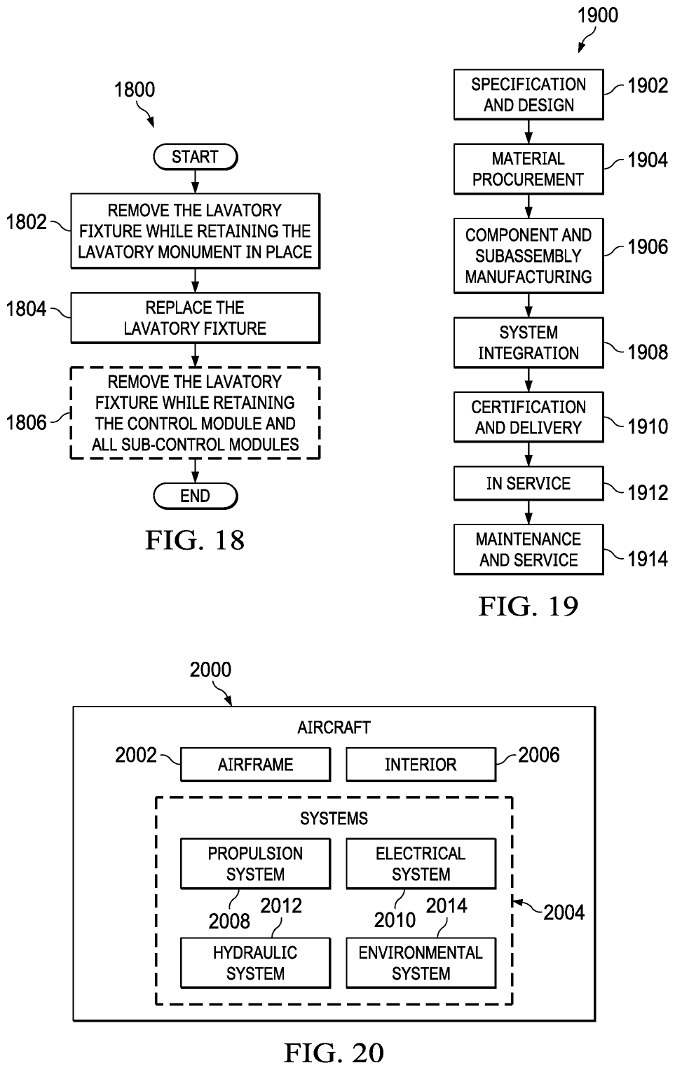

FIG. 18 is an illustration of a flowchart of a method for replacing a fixture in an aircraft modular lavatory monument in accordance with an illustrative embodiment. Method 1800 may be implemented in an aircraft, such as aircraft 1700 of FIG. 17 and aircraft 2000 of FIG. 20. Method 1800 may be characterized as a method of replacing a fixture in a lavatory monument of an aircraft while retaining the lavatory monument in place.

As indicated, method 1800 may be implemented in aircraft 1700 of FIG. 17. Thus, method 1800 may be implemented an aircraft including: a fuselage; a lavatory monument removably mounted inside the fuselage, wherein the lavatory monument further comprises: an outboard wall removably connected to an inside surface of the fuselage; a shell wall removably connected to the outboard wall and extending radially inwardly relative to the fuselage; a floor panel connected to and between the outboard wall and the shell wall; a toilet connected to the floor panel; and a plurality of lavatory fixtures individually removably attached to at least one of: the outboard wall, the shell wall, the floor panel, or the toilet, wherein each of the plurality of lavatory fixtures are configured to be individually removable, and wherein the lavatory fixture is one of the plurality of lavatory fixtures, and wherein common interface points on each of the plurality of lavatory fixtures are unchangeable with respect to the lavatory monument.

Method 1800 includes removing the lavatory fixture while retaining the lavatory monument in place (operation 1802). Method 1800 also includes replacing the lavatory fixture (operation 1804). In one illustrative embodiment, the method may terminate thereafter.

Method 1800 may be varied. For example, assume that the lavatory monument further includes: a control module connectable to an aircraft electrical umbilical, the control module removably connected to all of: an upper cabinet sub-component; an inboard wall sub-component; a toilet sub-component; a lower cabinet and backsplash sub-component; a systems panel and ceiling sub-component; and an aft wall sub-component. In this case, method 1800 may also include removing the lavatory fixture while retaining the control module and all sub-components (operation 1806). In one illustrative embodiment, the method may terminate thereafter.

Still other variations are possible. More or fewer operations may be present, or different operations may be present. The flowcharts and block diagrams in the different depicted embodiments illustrate the architecture, functionality, and operation of some possible implementations of apparatus and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added, in addition to the illustrated blocks, in a flowchart or block diagram. In some illustrative examples, not all blocks are performed and some blocks may be optional, in a flowchart or block diagram.

FIG. 19 is an illustration of an aircraft manufacturing and service method in the form of a block diagram depicted in accordance with an illustrative embodiment. FIG. 20 is an illustration of an aircraft in the form of a block diagram depicted in accordance with an illustrative embodiment.

Illustrative embodiments of the disclosure may be described in the context of aircraft manufacturing and service method 1900 as shown in FIG. 19 and aircraft 2000 as shown in FIG. 20. Turning first to FIG. 19, an illustration of an aircraft manufacturing and service method is depicted in accordance with an illustrative embodiment. During pre-production, aircraft manufacturing and service method 1900 may include specification and design 1902 of aircraft 2000 in FIG. 20 and material procurement 1904.

During production, component and subassembly manufacturing 1906 and system integration 1908 of aircraft 2000 in FIG. 20 takes place. Thereafter, aircraft 2000 in FIG. 20 may go through certification and delivery 1910 in order to be placed in service 1912. While in service 1912 by a customer, aircraft 2000 in FIG. 20 is scheduled for routine maintenance and service 1914, which may include modification, reconfiguration, refurbishment, and other maintenance or service.

Each of the processes of aircraft manufacturing and service method 1900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 20, an illustration of an aircraft is depicted in which an illustrative embodiment may be implemented. In this example, aircraft 2000 is produced by aircraft manufacturing and service method 1900 in FIG. 19 and may include airframe 2002 with plurality of systems 2004 and interior 2006. Examples of systems 2004 include one or more of propulsion system 2008, electrical system 2010, hydraulic system 2012, and environmental system 2014. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1900 in FIG. 19. One or more apparatus embodiments, method embodiments, or a combination thereof may be utilized during production stages, such as component and subassembly manufacturing 1906 and system integration 1908 in FIG. 19. In one illustrative example, components or subassemblies of an aircraft modular lavatory monument, such as lavatory monument 1704, may be produced and assembled in component and subassembly manufacturing 1906 in FIG. 19.

One or more apparatus embodiments, method embodiments, or a combination thereof may be utilized while aircraft 2000 is in service 1912 and/or during maintenance and service 1914 in FIG. 19. For example, assemblies or sub-assemblies of an aircraft modular lavatory monument, such as lavatory monument 1704, may be at least one of removed or replaced during maintenance and service 1914 in FIG. 19. The use of a number of the different illustrative embodiments may substantially expedite the assembly of and/or reduce the cost of aircraft 2000.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An aircraft comprising:
a fuselage;
a lavatory monument removably mounted inside the fuselage, wherein the lavatory monument further comprises:
an outboard wall removably connected to an inside surface of the fuselage;
a shell wall removably connected to the outboard wall and extending radially inwardly relative to the fuselage;
a floor panel connected to and between the outboard wall and the shell wall;
a toilet connected to the floor panel; and
a plurality of lavatory fixtures individually removably attached to at least one of: the outboard wall, the shell wall, the floor panel, or the toilet, wherein each of the plurality of lavatory fixtures are configured to be individually removable, and wherein common interface points on each of the plurality of lavatory fixtures are unchangeable with respect to the lavatory monument.

2. The aircraft of claim 1 further comprising:
a ballistic intrusion barrier connected to the outboard wall adjacent the ballistic intrusion barrier and extending radially inwardly relative to the fuselage.

3. The aircraft of claim 1, wherein one of the plurality of lavatory fixtures comprises a toilet shroud removably attached to the toilet, the toilet shroud also connected to the outboard wall.

4. The aircraft of claim 1 further comprising:
an aft wall removably attached to the outboard wall opposite the shell wall and extending radially inwardly relative to the fuselage; and
a plurality of non-lavatory fixtures connected to a second side of the aft wall, wherein a first side of the aft wall faces an interior of the lavatory monument.

5. The aircraft of claim 4, wherein the plurality of non-lavatory fixtures comprises one or more of the group consisting of: a computer, a display, a cabinet, a drawer, a lock-box, and an instrument panel.

6. The aircraft of claim 1, wherein the plurality of lavatory fixtures comprises two or more objects selected from the group consisting of: a sink, a faucet, a cabinet, an alcove panel shaped to present an alcove inside the lavatory monument, a toilet paper holder, a drawer, a liquid hose line, a soap dispenser, a soap holder, a towel dispenser, a towel holder, a drawer, a backsplash, a waste receptacle, a counter top, a light strip, a light bulb, a lightable sign, a mirror, a display device, a speaker, a crew signal button, a switch, a panel, a cup holder, an airsick bag dispenser, a tissue dispenser, a sanitary napkin dispenser, a cologne rack, and a shelf.

7. The aircraft of claim 1, wherein the lavatory monument further comprises:
a door connected to the shell wall.

8. The aircraft of claim 7, wherein the door further comprises one of a folding door and a slab door.

9. The aircraft of claim 7, wherein the door further comprises a lock which, when actuated, activates all of: locking the door, activating a no-vacancy sign displayed outside the door, and a lighting scenery scheme.

10. The aircraft of claim 1, wherein the lavatory monument further comprises:
a floor pan removably connected to the floor panel of the lavatory monument in front of the toilet.

11. The aircraft of claim 1, wherein one or more of the plurality of lavatory fixtures comprises a plurality of sub-assemblies that are removably connected to a given lavatory fixture such that removal and replacement of one of the plurality of sub-assemblies does not require removal of any other of the plurality of sub-assemblies.

12. The aircraft of claim 1, wherein the aircraft further comprises:
an electrical wiring system, wherein each of the plurality of lavatory fixtures that require electricity is removably connected to the electrical wiring system.

13. The aircraft of claim 12, wherein the aircraft further comprises:
a computer, wherein the lavatory monument is removably connectable to the computer and the computer is configured to control one or both of: electrical fixtures or display fixtures in the lavatory monument.

14. The aircraft of claim 1, wherein the aircraft further comprises:
an air duct system, wherein the lavatory monument has an air duct that is removably connectable to the air duct system.

15. The aircraft of claim 1, wherein the plurality of lavatory fixtures comprises a faucet, a fluid line, a sink, a drain, and a backsplash, wherein the faucet is removably connected to the fluid line, the fluid line is removably connected to the backsplash, the sink is removably connected to the shell wall, and the drain is removably connected to the sink.

16. The aircraft of claim 1, wherein the plurality of lavatory fixtures further comprises:
lighting removably disposed underneath a counter at about foot level.

17. The aircraft of claim 1, wherein the lavatory monument further comprises:
a control module connectable to an aircraft electrical umbilical, the control module removably connected to all of:
an upper cabinet sub-component;
an inboard wall sub-component;
a toilet sub-component;
a lower cabinet and backsplash sub-component;
a systems panel and ceiling sub-component; and
an aft wall sub-component.

18. The aircraft of claim 17, wherein the aircraft electrical umbilical is also removably connectable to the aft wall sub-component and the systems panel and ceiling sub-component.

19. A method of replacing a lavatory fixture in a lavatory monument of an aircraft while retaining the lavatory monument in place, the method implemented in an aircraft comprising: a fuselage; a lavatory monument removably mounted inside the fuselage, wherein the lavatory monument further comprises: an outboard wall removably connected to an inside surface of the fuselage; a shell wall removably connected to the outboard wall and extending radially inwardly relative to the fuselage; a floor panel connected to and between the outboard wall and the shell wall; a toilet connected to the floor panel; and a plurality of lavatory fixtures individually removably attached to at least one of: the outboard wall, the shell wall, the floor panel, or the toilet, wherein each of the plurality of lavatory fixtures is configured to be individually removable, wherein the lavatory fixture is one of the plurality of lavatory fixtures, and wherein common interface points on each of the plurality of lavatory fixtures are unchangeable with respect to the lavatory monument, the method comprising:
removing the lavatory fixture while retaining the lavatory monument in place; and
replacing the lavatory fixture.

20. The method of claim 19, wherein the lavatory monument further comprises: a control module connectable to an aircraft electrical umbilical, the control module removably connected to all of: an upper cabinet sub-component; an inboard wall sub-component; a toilet sub-component; a lower cabinet and backsplash sub-component; a systems panel and ceiling sub-component; and an aft wall sub-component, and wherein the method further comprises:
removing the lavatory fixture while retaining the control module and all sub-components.
